(19) United States
(12) Patent Application Publication
(10) Pub. No.: US 2025/0199766 A1
(43) Pub. Date: Jun. 19, 2025

(54) RealFlow Multiplier Algorithm

(71) Applicant: Omar Ali Zargelin, Redford, MI (US)

(72) Inventor: Omar Ali Zargelin, Redford, MI (US)

(21) Appl. No.: 18/919,139

(22) Filed: Oct. 17, 2024

(51) Int. Cl. G06F 7/523

(52) U.S. Cl. CPC G06F 7/523

(57) ABSTRACT

This patent abstract outlines a groundbreaking invention within the domain of mathematical algorithms and techniques, focusing on innovative approaches to arithmetic calculations, particularly multiplication. The invention introduces novel algorithmic strategies prioritizing efficient, rapid, and precise multiplication computations while diverging from conventional methods. It leverages fundamental arithmetic operations, works for any number of multiplicands and multipliers, operates in parallel for multiple multiplicand numbers, and remarkably, does not require computations beyond 13 due to its avoidance of redundant multiplicand digit values. Meticulously tailored for real-time computational environments, it emphasizes speed, accuracy, and optimal resource utilization. This innovation seamlessly aligns with evolving educational paradigms and technological advancements, extending its applicability from basic calculators to cutting-edge computational systems. Its overarching goal is to reshape and elevate traditional multiplication benchmarks.

### FIELD OF THE TECHNOLOGY

The present invention falls within the domain of mathematical algorithms and techniques. It primarily concerns methods used in arithmetic calculations, with an emphasis on multiplication. In a broader sense, it encapsulates innovative systems and methods that can reshape traditional mathematical processes to align with evolving educational paradigms and technological advancements.

### BACKGROUND

Multiplication, a fundamental arithmetic operation, has evolved significantly since its origins in ancient civilizations. Early societies developed basic methods for multiplication, which served them well for their time. However, with the advent of the digital age, the need for more advanced and efficient algorithms became essential. The rapid growth of digital systems and the increasing size of data required innovative multiplication methods that could keep pace with the expanding demands of electronic computations.

As digital systems have grown, so too has the complexity of the numbers being handled. Traditional multiplication methods, while effective for smaller calculations, often face limitations when applied to large-scale data or real-time processing. The challenges posed by floating-point operations, precision errors, and the heavy computational resources needed to manage such calculations have highlighted the inefficiencies of older techniques. These issues are particularly problematic in areas that require both speed and precision, such as high-performance computing and data analytics.

Modern algorithms, such as Karatsuba and FFT-based approaches, have made significant strides in improving multiplication efficiency. These methods reduce the number of steps required for large-number multiplications, which increases speed. However, they often struggle to maintain accuracy, especially when dealing with floating-point numbers or large datasets. In fields like cryptography and real-time simulations, even small inaccuracies can lead to significant errors, making the trade-off between speed and precision a critical challenge for many existing algorithms.

The increasing complexity of contemporary computational needs—driven by fields like Big Data, machine learning, and the Internet of Things (IoT)—requires algorithms that not only handle large datasets with speed and precision but also adapt to real-time processing requirements. To address these needs, the Real Flow Multiplier Algorithm (RFMA), based on the Zargelin Mathematical Chain (ZMC), offers a comprehensive solution.

RFMA is designed to handle numbers of any size, ensuring 100% accuracy while processing data in real-time. It also addresses the common issue of floating-point inaccuracies, providing a reliable and efficient alternative to existing methods. By eliminating redundant computations and optimizing operations to work in parallel across multiple data streams, RFMA achieves unparalleled scalability and efficiency, positioning itself as a transformative solution for modern digital computation.

### SUMMARY OF THE INVENTION

The RealFlow Multiplier Algorithm (RFMA): An Innovative Leap in Multiplication with 13 Segments Ranging from 0 to 12.

Purpose of the RealFlow Multiplier Algorithm (RFMA): The RFMA is designed to address and alleviate challenges across a multitude of sectors, including finance, technology, sciences, and education. Its inherent capabilities allow for real-time calculations, managing an unlimited range of numbers efficiently. Not only does it offer swifter computational processes, but it also provides an intuitive solution to the pervasive floating-point issues. By harnessing the power of RFMA, users can expect a transformative approach to mathematical computations, streamlining tasks and enhancing accuracy across varied applications.

The Real Flow Multiplier Algorithm (RFMA), as illustrated in FIG. 1, provides a systematic approach to multiplication. The process begins with the initialization of RFMA and the setting of various variables to zero, ensuring accurate calculations. The algorithm takes into account the signs of the multiplicands, manages decimal points, and reads the multiplicand digit by digit for precise computation. If any operation other than multiplication is detected, an error is displayed. A Real-time Function called Curses is introduced, facilitating real-time computations. The Final Result Sign (FRS) is adjusted according to the signs of both the multiplicand and multiplier. If a decimal point is found during processing, the Decimal Fraction (DF) is incremented. The RFMA then delves into its intricate segments for detailed processing. The final result is computed by aggregating all individual results, adjusted for decimal fractions. The algorithm concludes with the completion of the RFMA process, ensuring accurate multiplication results in real-time.

The RealFlow Multiplier Algorithm, abbreviated as RFMA, marks a transformative advancement in the realm of multiplication methodologies. Stemming from the foundational concepts of the Zargelin Mathematical Chain (ZMC) as shown in FIG. 3—an innovative notion we previously brought to light—the RFMA elevates the ZMC's principles even further. It boasts a range of features that arguably position it as a leading-edge contender in today's mathematical algorithmic landscape.

Central to RFMA's allure is its astonishing speed, unparalleled efficiency, and the capability to execute real-time calculations. Its prowess in handling infinite multipliers translates complex multiplication processes into seemingly effortless tasks. While it stands out for its impeccable accuracy, its design ensures that this precision doesn't come at an excessive computational expense, making RFMA both accurate and resource-conservative.

RFMA boasts another noteworthy trait in its adaptability. This characteristic renders it suitable for a wide range of applications, from handling intricate computational tasks in advanced computing environments to serving as a dependable tool for everyday basic calculations. RFMA's versatility makes it a valuable asset across diverse scenarios and computing requirements.

The Real Flow Multiplier Algorithm (RFMA) represents an advanced mathematical approach optimized for rapid and efficient multiplication operations. Key attributes of RFMA include real-time computational capabilities and exceptional proficiency in handling infinite multipliers and converting intricate multiplication tasks into streamlined operations. The design prioritizes both accuracy and computational economy. Potential applications span diverse sectors, including but not limited to finance, scientific research, education, technology, engineering, space exploration, telecommunications, medical research, weather modeling, cryptography, and e-commerce.

One remarkable aspect of RFMA is its adept handling of floating-point multiplication intricacies, all achieved without relying on extensive multiplication tables. By adopting a left-to-right operational approach, RFMA pioneers simultaneous processing of multiplicand digits. This innovation not only accelerates computation but also enhances precision significantly.

Resource utilization stands as a testament to its efficiency. Remarkably, regardless of the size of the multipliers, the RFMA requires no more than 13 parallel counts. What's even more commendable is that with numbers having similar digits, the algorithm intelligently copies from prior results, effectively sidestepping redundant calculations.

In today's rapid digital landscape, real-time adaptability is paramount. RFMA, seamlessly integrated with “curses” and analogous real-time functions, addresses contemporary computational needs proficiently. Parallelly, real-time multiplication carves out expansive applications. Interactive Systems: They stand out by providing immediate results as users input digits, streamlining user engagement. Embedded Systems: Operating within tight resource constraints, these systems greatly benefit from on-the-spot computations. Financial platforms, by offering swift calculations, markedly uplift user experience. Meanwhile, educational tools that leverage this approach are pioneering new teaching paradigms, with immediate feedback bolstering both understanding and retention. Collectively, these advancements highlight the indispensable role of real-time solutions in the evolving digital era.

The Real Flow Multiplier Algorithm (RFMA) stands apart by introducing novel methodologies that permit swifter calculations, making it particularly advantageous in real-time scenarios. Its uniqueness also lies in its approach to multiplication: it diverges entirely from traditional multiplication methods. Unlike some prior solutions, RFMA boasts the ability to manage infinite multipliers and offers unmatched computational efficiency without unduly taxing resources. In essence, no other known methods or solutions combine speed, efficiency, and real-time prowess in the manner that RFMA does.

Table 1 comprehensively details the RFMA's part-algorithms, each tailored for specific multiplicand values. Its structure enables quick navigation through the RFMA system, allowing users to identify the suitable part-algorithm for multiplication tasks. Notably, pairs like RFMA-11 with RFMA-6, RFMA-12 with RFMA-7, RFMA-10 with RFMA-5, RFMA-9 with RFMA-4, and RFMA-8 with RFMA-3, reveal an inherent symmetry in the RFMA system, which is crucial for simplifying the multiplication process. Recognizing the shared principle between paired algorithms enhances users' efficiency and clarity when navigating the RFMA.

TABLE 1

| * | Multiplier Sequence (a:bᵢ:c) | Rule | m |
|---|---|---|---|
| 12 | a:bᵢ + 2bᵢ₋₁:2c | Double & add | 1 |
| 7 | $int ( \frac{a}{2} ) : int ( \frac{{b}_{i}}{2} ) + \{ \begin{matrix}2 {b}_{i - 1} if {b}_{i - 1} is E \\ 2 {b}_{i - 1} + 5 else\end{matrix} : \{ \begin{matrix}2 c if c is E \\ 2 c + 5 else\end{matrix}$ | Double & add with the half | 2 |
| 11 | a:bᵢ + bᵢ₋₁:c | Add | 3 |
| 6 | $int ( \frac{a}{2} ) : int ( \frac{{b}_{i}}{2} ) + \{ \begin{matrix}{b}_{i - 1} if {b}_{i - 1} is E \\ {b}_{i - 1} + 5 else\end{matrix} : \{ \begin{matrix}c if c is E \\ c + 5 else\end{matrix}$ | Add with the half | 4 |
| 10 | a:bᵢ:c | Zero & add | 5 |
| 5 | $int ( \frac{a}{2} ) : int ( \frac{{b}_{i}}{2} ) + \{ \begin{matrix}0 if {b}_{i - 1} is E \\ 5 else\end{matrix} : \{ \begin{matrix}0 if c is E \\ 5 else\end{matrix}$ | Zero & add with the half | 6 |
| 9 | a − 1:bᵢ + 9 − bᵢ₋₁:10 − c | Complement & add | 7 |
| 4 | $int ( \frac{a}{2} ) - 1 : int ( \frac{{b}_{i}}{2} ) + \{ \begin{matrix}9 - {b}_{i - 1} if {b}_{i - 1} is E \\ 9 - {b}_{i - 1} + 5 else\end{matrix} : \{ \begin{matrix}10 - c if c is E \\ 10 - c + 5 else\end{matrix}$ | complement & add with the half | 8 |
| 8 | a − 2:bᵢ + 2(9 − bᵢ₋₁):2(10 − c) | Double complement & add | 9 |
| 3 | $int ( \frac{a}{2} ) 2 : int ( \frac{{b}_{i}}{2} ) + \{ \begin{matrix}2 ( 9 - {b}_{i - 1} ) if {b}_{i - 1} is E \\ 2 ( 9 - {b}_{i - 1} ) + 5 else\end{matrix} : \{ \begin{matrix}2 ( 10 - c ) if c is E \\ 2 ( 10 - c ) + 5 else\end{matrix}$ | Double complement & add with the half | 10 |

The RFMA, or Real Flow Multiplier Algorithm, provides an innovative yet methodical approach to multiplication by utilizing a series of structured part-algorithms. Each of these part-algorithms is meticulously tailored for specific multiplicand values. The table serves as a central reference, breaking down the RFMA into its fundamental sub-algorithms, facilitating clarity and precision in the multiplication process.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 presents the comprehensive flowchart of the RealFlow Multiplier Algorithm (RFMA), encompassing references to all 13 distinct parts of the invention.

FIG. 2 depicts the universal flowchart encompassing all 13 steps of RFMA-parts, which remain valid across the board and can operate effectively with adjustments to only two variables: R_{dv} and sum in the second and third sections.

FIG. 3 illustrates the fundamental concept of the Zargelin Mathematical Chain (ZMC), which enables both mental and non-mental multiplication processes without the need for multiplication tables, and it can be applied to unlimited numbers.

FIG. 4 presents a flowchart depicting the general decimal convolution method, an alternative approach for performing multiplication.

### DETAILED DESCRIPTION

The RFMA production primarily leverages two key strategies: employing decimal convolution and utilizing two-digit multiplicands. Decimal convolution facilitates efficient calculations in the decimal number system. Meanwhile, working with two-digit multiplicands, rather than the conventional single-digit approach, enables computations to process two digits simultaneously in each operation, enhancing the efficiency and speed of calculations.

The present invention pertains to a novel method for data processing, termed as “decimal convolution.” Traditionally, convolution operations, widely used in fields such as signal processing and machine learning, particularly in deep neural networks, work in the domain of integers or floating-point numbers. However, the proposed decimal convolution leverages the intricacies of decimal-based arithmetic to perform convolution operations. In this method, data represented in the decimal system is directly convolved without the typical conversion into other numeric representations. By maintaining data in its decimal form, the method potentially allows for enhanced precision, reduced computational overhead, and greater alignment with certain specific hardware designs. The architecture of the system performing the decimal convolution is uniquely designed to handle decimal-based arithmetic operations, providing optimized performance and energy efficiency for tasks that benefit from decimal computations. This invention provides a significant advancement in computational efficiency and potential applications in various industries, especially where decimal precision is crucial.

In the general decimal convolution method for multiplication, two numbers are treated in a manner analogous to the convolution operation in signal processing. Let's denote the multiplicand as A and the multiplier as B. Instead of a traditional multiplication method, A is interpreted in its reversed form and moved across B, digit by digit. For each position of A over B, a partial product is calculated based on the overlapping digits. These products are then summed, taking into account their positional weight, to yield the final multiplication result. This process continues until all digits of A have convolved with all digits of B. One significant advantage of this method is its general applicability: irrespective of the lengths of A and B, the procedure remains consistent. It involves digit-wise multiplication and accumulation, ensuring efficient computation for numbers of any magnitude.

Decimal convolution offers a compelling solution for multiplication, ensuring near-instantaneous results even for numbers of vast magnitudes. Its efficiency is such that, regardless of the multiplier's size, the computation time is predominantly dominated by the simple task of displaying or printing the result. In essence, upon initiating the operation (like pressing the ‘=’ button), the method's inherent optimization delivers the outcome immediately, making it seem as if the only ‘waiting’ time is for the result to be rendered on the screen or print medium. This level of real-time performance, especially for unlimited multipliers, underscores the method's potential in high-demand computational environments.

The general decimal convolution method, while innovative and potentially efficient, presents some challenges that may impede its wide-scale implementation, especially in computer architectures. One of the primary issues arises when dealing with large numbers. The sheer size of these numbers necessitates the use of a very large register. As the number of digits in the multiplicand or multiplier increases, the required register space grows accordingly, straining the computational resources and possibly leading to inefficiencies in data storage and retrieval.

Furthermore, when the general decimal convolution method is juxtaposed with other multiplication approaches, specifically ‘multiplication without multiplication’ methods, a different set of challenges emerges. In these methods, multiplication is replaced by a series of other operations, often reliant on specific rules for individual digits, such as the rule for the digit ‘7’. The need to repeatedly apply these rules for every digit can compound the computational effort, potentially making the process cumbersome and elongating the execution time. As a result, while the method offers a distinct perspective on multiplication, it might not always be the most efficient choice in practical scenarios.

TABLE. 2 illustrates a classic 3×2 Long Multiplication Operation, specifically, 312×23. In this method, the three-digit number, 312, is multiplied by the two-digit number, 23. The procedure begins by multiplying 312 by the rightmost digit of the multiplier, which is 3, resulting in 936. When multiplying by the next digit, 2, the outcome is 624, positioned one place to the left. By aggregating these partial results, we obtain a total of 7,176. This methodical breakdown, progressing column by column, highlights the accuracy of the traditional multiplication technique, demonstrating the impactful role each digit plays in the cumulative total.

TABLE 2

| | | | | |
|---|---|---|---|---|
| | 3 | 1 | 2 | Multiplicand |
| | x | 2 | 3 | Multiplier |
| | 9 | 3 | 6 | 3 × 312 |
| 6 | 2 | 4 | | 2 × 312 |
| 6 | 11 | 7 | 6 | Sum |
| 7 | 1 | 7 | 6 | Result |

TABLE. 3 illustrates the Decimal Convolution method for the 3×2 Multiplication of 312×23, denoted as 312⊗23, where ⊗ represents the convolution symbol. Initially, 23 is reversed to 32 and aligned with 312. The method involves specific overlaps, starting with aligning 32's rightmost digit with 312's leftmost digit to obtain 6. The subsequent rightward shift pairs 32's 2 with 312's middle digit, yielding 2, and its 3 with the leftmost digit, yielding 9. Another shift aligns the 2 from 32 with the rightmost digit of 312, resulting in 4, and its 3 with the middle digit, resulting in 3. The final overlap of the leftmost digit of 32 with the rightmost digit of 312 gives 6. Cumulatively, these overlaps yield 6, 11, 7, and 6. After accounting for carryovers, the product is 7,176. Notably, overlaps shift to the right, mirroring the shifts in traditional multiplication.

Note: It's important to recognize that with each subsequent step, the overlaps effectively shift to the right, akin to how digits shift in traditional multiplication.

TABLE 3

| | | | | |
|---|---|---|---|---|
| Number of steps | 1 | 2 | 3 | 4 |

| ⊗ | | | 3 | 1 | 2 | |
|---|---|---|---|---|---|---|
| → | | | | | | |
| | 3 | 2 | 6 | | | |
| | | | | 2 | | |
| | | | | 9 | 4 | |
| | | | | | 3 | 6 |

| | | | | |
|---|---|---|---|---|
| Sum | 6 | 11 | 7 | 6 |
| result | 7 | 1 | 7 | 6 |

Table 4 showcases the Decimal Convolution method applied to a standard 3×2 multiplication of 978 and 98, represented as 978⊗98. Using this innovative technique, the number 98 is inverted to 89 and overlapped with 978. Initially, the 9 from 89 aligns with the leftmost 9 of 978 to produce 81. The next overlap merges the same 9 with 978's middle 7 for 63, while the 8 combines with the leading 9 to give 72, summing up to 135. In the third step, the 9 overlaps with 978's final 8 to yield 72, and the 8 pairs with the middle 7 for 56, leading to a total of 128. The last alignment of 8 from 89 with the last 8 of 978 results in 64. After summing these values and accounting for carryovers, the convolution method concludes with a product of 95,884.

TABLE 4

| | | | | |
|---|---|---|---|---|
| Number of steps | 1 | 2 | 3 | 4 |

| ⊗ | | | 9 | 7 | 8 | |
|---|---|---|---|---|---|---|
| → | | | | | | |
| | 8 | 9 | 81 | | | |
| | | | | 63 | | |
| | | | | 72 | 72 | |
| | | | | | 56 | 64 |

| | | | | |
|---|---|---|---|---|
| Sum | 81 | 135 | 128 | 64 |
| result | 95 | 8 | 4 | 4 |

Table 5 showcases a 4×3 Extended Multiplication example. By employing standard long multiplication with the four-digit number, 4132, and the three-digit number, 123, we begin with the rightmost digit, 3, of the multiplier. This multiplication with 4,132 yields 12,396. Transitioning to the next digit, 2, the result is 8,264, though offset by one column to the left. Multiplying the leading digit, 1, gives 4,132, with an offset of two columns to the left. When these values are combined, the total is 508,236. This structured approach, processed column by column, emphasizes the meticulousness of

TABLE 5

| | | | | | | |
|---|---|---|---|---|---|---|
| | | 4 | 1 | 3 | 2 | Multiplicand |
| | | | 1 | 2 | 3 | Multiplier |
| | 1 | 2 | 3 | 9 | 6 | 3 × 4132 |
| | 8 | 2 | 6 | 4 | | 2 × 4132 |
| 4 | 1 | 3 | 2 | | | 1 × 4132 |
| 5 | 0 | 8 | 2 | 3 | 6 | Result |

conventional multiplication, highlighting the critical role each digit plays in arriving at the final product.

Table 6 exemplifies the Decimal Convolution technique in action, specifically with the multiplication of 123 and 4123. In this innovative approach, 123 is inverted to 321 and methodically overlapped with 4123 from left to right. The outset sees the 1 from 321 matching with the leftmost 4 of 4123, resulting in 4. During the next phase, overlaps between 1 of 321 with 1 of 4123 yield 1, while 2 of 321 combined with the leading 4 of 4123 produce 8, aggregating to 9. As the sequence advances, 1 of 321 aligns with 2 of 4123 for 2, 2 of 321 with 1

TABLE 6

| Number of steps | | | 1 | 2 | 3 | 4 | 5 | 6 |
|---|---|---|---|---|---|---|---|---|
| ⊗ | | | 4 | 1 | 2 | 3 | | |
| → | | | | | | | | |
| 3 | 2 | 1 | 4 | 1 | | | | |
| | | | | 8 | 2 | | | |
| | | | | | 2 | 3 | | |
| | | | | | 12 | 4 | 6 | |
| | | | | | | 3 | 6 | 9 |

| | | | | | | |
|---|---|---|---|---|---|---|
| Sum | 4 | 9 | 16 | 10 | 12 | 9 |
| result | 5 | 0 | 7 | 1 | 2 | 9 |

of 4123 gives 2, and 3 of 321 with the primary 4 of 4123 results in 12, collectively summing to 16. Further progression brings forth an aggregate of 10 as 1 with 3 results in 3, 2 with 2 gives 4, and 3 with 1 provides 3. Nearing conclusion, the penultimate overlap of 2 with 3 and 3 with 2 collectively offer 12. The finale is marked by the singular overlap of 3 with 3, churning out 9. After meticulous carry-over adjustments, this Decimal Convolution process delivers a final product of 507,129, showcasing not just its precision, but also its robust potential as a viable alternative to conventional multiplication methods.

Table 7 exemplifies the Decimal Convolution technique in action, specifically with the multiplication of 123 and 4123. In this innovative approach, 123 is inverted to 321 and methodically overlapped with 4123 from left to right. The outset sees the 1 from 321 matching with the leftmost 4 of 4123, resulting in 4. During the next phase, overlaps between 1 of 321 with 1 of 4123 yield 1, while 2 of 321 combined with the leading 4 of 4123 produce 8, aggregating to 9. As the sequence advances, 1 of 321 aligns with 2 of 4123 for 2, 2 of 321 with 1 of 4123 gives 2, and 3 of 321 with the primary 4 of 4123 results in 12, collectively summing to 16. Further progression brings forth an aggregate of 10 as 1 with 3 results in 3, 2 with 2 gives 4, and 3 with 1 provides 3. Nearing conclusion, the penultimate overlap of 2 with 3 and 3 with 2 collectively offer 12. The finale is marked by the singular overlap of 3 with 3, churning out 9.

TABLE 7

| Number of steps | | | | 1 | 2 | 3 | 4 | 5 | 6 |
|---|---|---|---|---|---|---|---|---|---|
| ⊗ | | | | 1 | 2 | 3 | | | |
| → | | | | | | | | | |
| 3 | 2 | 1 | 4 | 4 | | | | | |
| | | | | | 8 | | | | |
| | | | | | 1 | 12 | | | |
| | | | | | | 2 | 3 | | |
| | | | | | | 2 | 4 | 6 | |
| | | | | | | | 3 | 6 | 9 |

| | | | | | | |
|---|---|---|---|---|---|---|
| Sum | 4 | 9 | 16 | 10 | 12 | 9 |
| result | 5 | 0 | 7 | 1 | 2 | 9 |

After meticulous carry-over adjustments, this Decimal Convolution process delivers a final product of 507,129, showcasing not just its precision, but also its robust potential as a viable alternative to conventional multiplication methods.

In the realm of computational efficiency, the proposed algorithm introduces a significant breakthrough for handling multiplicands. By intelligently reading and analyzing the digits of the multiplicand, the algorithm discerns repeated digit values and strategically determines storage registers for them. Instead of repetitively executing the part-algorithm for each occurrence of the same digit value, the algorithm optimally runs the part-algorithm just once. This not only reduces the computational overhead but also considerably trims down processing time. Such an approach offers a dual benefit: it conserves processing resources and ensures swifter calculations, making the algorithm particularly advantageous for systems where time and resource efficiency are paramount.

Introduced in this invention, the Real Flow Multiplier Algorithm (RFMA) represents a novel stride in computational prowess. While many algorithms flexibly adjust their parallelism depending on the input size, the RFMA stands out by setting a steadfast limit, allowing no more than 13 part-algorithms to operate in tandem regardless of the size of multiplicand and multiplier. This distinctive trait guarantees stable and enhanced performance across various processor types, from multicore CPUs and GPUs to bespoke ASICs. Given its unwavering efficiency regardless of input dimensions, the RFMA proves especially advantageous for processors with constrained parallel capabilities, positioning it as a vital tool in both existing and forthcoming computational frameworks.

Method for Sign Handling During Decimal Multiplication: The present invention introduces a systematic approach to handle the sign during the multiplication of two decimal numbers, A and B. Upon determining the individual signs of A and B, if both numbers share the same sign, the resulting product is deemed positive. Conversely, if A and B possess opposing signs, the resulting product is negative. The multiplication then proceeds using the absolute values of A and B, and the determined sign is subsequently applied to the product. This method ensures consistent and error-free sign determination, providing a clear computational advantage in automated systems and applications.

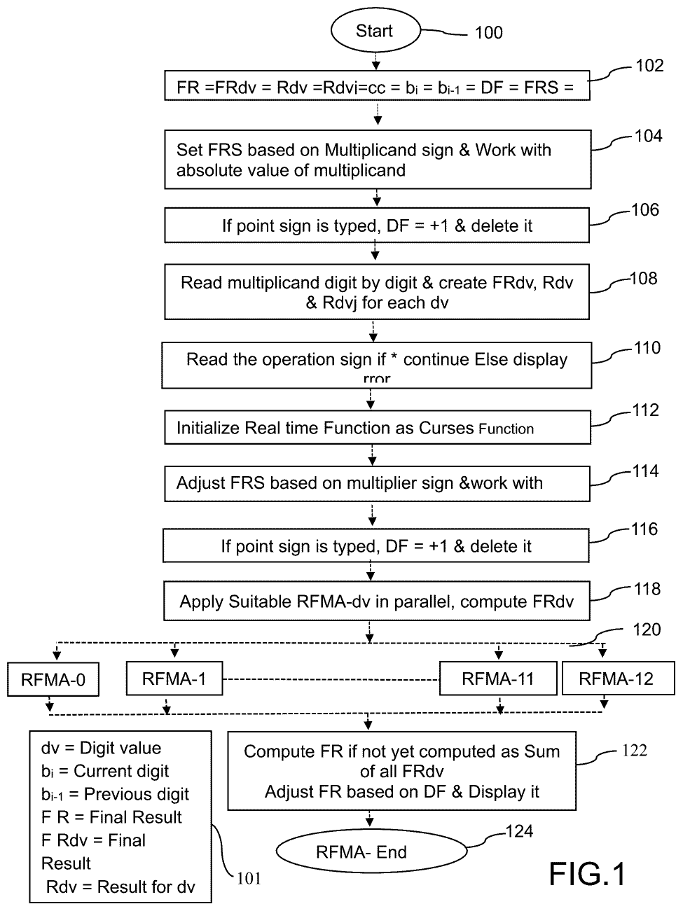

In FIG. 1, the depicted flowchart methodically outlines the sequential steps involved in executing the Real Flow Multiplier Algorithm (RFMA). The process initiates at step 100 with the start of RFMA, setting the foundation for the algorithm's operation. Following the commencement, step 102 initializes several variables such as FR, FR_{dv}, R_{dv}, R_{dvj}, CC, bᵢ, bᵢ₋₁, DF, and FRS to zero, thereby ensuring a clean slate for the computations ahead. CC counts carryover digits for placing the first left digit in position.

Subsequently, step 104 is dedicated to setting FRS based on the multiplicand sign and working with the absolute value of the multiplicand, establishing the groundwork for further calculations. The algorithm then proceeds to step 106, where it checks for a decimal point. If encountered, DF is set to +1, and the decimal point is deleted. In step 108, the multiplicand is handled digit by digit, and respective FR_{dv}, R_{dv}, and R_{dvj} are created for each digit value (dv).

Ensuring accuracy in the operation, step 110 reads the operation. If multiplication is detected, the process continues; otherwise, an error is displayed, signifying an incorrect operation. Step 112 is essential for initializing the Real-time Function as Curses, paving the way for real-time adjustments and computations. Step 114 plays a crucial role in adjusting the Final Result Sign (FRS) based on the multiplier sign; if the signs are similar and positive, it remains unchanged; otherwise, it is altered. This step ensures the correct sign of the final result, taking into account the signs of both the multiplicand and the multiplier.

Another check for a decimal point occurs at step 116 with similar actions as before, when a decimal is identified, it triggers the increment of the Decimal Fraction (DF) by +1 and eliminates the decimal point, considering there is no decimal fraction left. Following this, step 118 applies suitable RFMA-dv in parallel until an ‘equals’ sign is inputted, at which point the algorithm computes FRdv's and exits this segment. Delving into the RFMA parts in step 120, it is here that the intricate segments of the RFMA are analyzed and processed.

The penultimate step, 122, involves calculating the Final Result (FR) as the sum of all FRdv. Upon determining the final result, it is then adjusted according to the total count of DF, ensuring accuracy and precision in the algorithm's output. The role of DF is crucial in this step as it directly impacts the final result's accuracy and reliability. Lastly, step 124 marks the end of RFMA, signifying the completion of the Real Flow Multiplier Algorithm. This comprehensive flowchart, complemented by the definitions provided in step 101, offers a structured and detailed overview of the RFMA, enhancing understanding and implementation of this algorithm.

The efficient functioning of the RFMA hinges on its initial setup, primarily involving register initialization. Registers follow the format R_{dvj}, where R denotes the result, j is an iterator up to the multiplicand's digit count, and dv signifies the digit value, notated as I, II, through to XII. Key terminologies include bᵢ for the current digit, bᵢ₋₁ for the preceding digit, FR for the final result, and DF for decimal fractions.

Here, it is important to clarify how the temporary register are managed and the different scenarios involved in calculating the final result (FR) with more detailed explanation. Since the number of multiplicand digits and their values are known before the algorithm starts, the required number of temporary registers can be determined in advance. This precomputation allows for optimizing the allocation of resources based on the specific needs of the multiplication task. In certain cases, such as when multiplicand just single-digit or even two-digit numbers, the use of temporary registers may not be necessary at all. The simplicity of these calculations allows the algorithm to proceed without the need for intermediate storage.

In cases where all the digits of the multiplicand are identical, such as in the case of the multiplicand 33333333, a single temporary register can be used to store the intermediate result of the repeated multiplication. Since the same multiplication operation is performed for each identical digit, the multiplication result can be reused across all digits of the multiplicand. This approach significantly reduces the computational complexity of the algorithm by eliminating the need for multiple temporary registers, thus optimizing the efficiency of the calculation process regardless of the size of the multiplicand or the multiplier. In the Real Flow Multiplication Algorithm, two approaches for handling temporary registers are considered. The first uses separate registers for each digit's intermediate result, while the second directly adds the result to the final output without additional registers. The second approach, especially for identical multiplicand digits, reduces computational complexity and enhances efficiency without loss of accuracy.

The first approach, where temporary registers are used for each multiplicand digit, offers several advantages. It introduces a more structured and modular framework to the algorithm, allowing for the isolation and storage of intermediate results for each digit. This method facilitates easier debugging and tracking of the calculations, as individual digits' results can be checked before contributing to the final outcome. Additionally, this approach can simplify carry handling, as the intermediate results are stored and processed separately. However, this method requires more memory due to the need to allocate a register for each digit, and in cases involving larger numbers, the performance may be slowed by the increased overhead of managing multiple registers.

The second approach, where the multiplication result is added directly to the final result without using temporary registers, offers enhanced memory efficiency. By eliminating the need for additional storage of intermediate results, this approach significantly reduces memory consumption, which can be crucial in environments with limited resources. Furthermore, this method can improve computation speed since it avoids the overhead associated with managing multiple registers. However, this approach can complicate debugging, as intermediate results are not stored separately, making it harder to trace calculation steps. Additionally, managing carry operations becomes more challenging due to the continuous modification of the final result during the multiplication process.

Ultimately, the choice between these two approaches depends on the optimization goals. For environments prioritizing memory efficiency and faster computation, the second approach, involving direct addition to the final result, is preferable. In contrast, if modularity, clarity, or the need for easy debugging is more important, and sufficient memory is available, the first approach, using temporary registers, is more suitable.

### For all RealFlow Multiplier—Part Algorithms

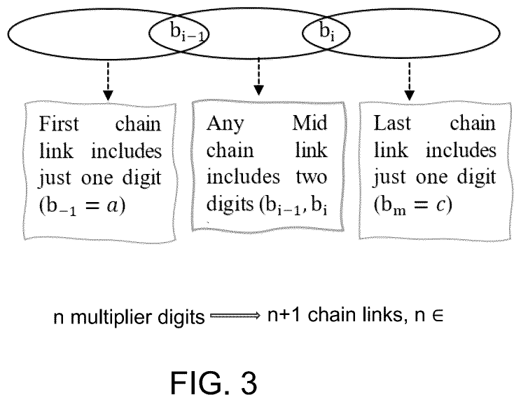

The RealFlow Multiplier Algorithm (RFMA), showcased in FIG. 3, employs 13 interconnected algorithm parts to manage the multiplication process in three sections: single-digit processing for the beginning and ending sections and concurrent two-digit processing for the central segment. Utilizing a modular design, each part-algorithm has specific calculations detailed in a private table, maintaining consistency across components numbered 0-12. The multiplier is expressed as the sequence (a: bi: c), emphasizing its distinct digits, while the colon symbol (:) delineates positional values in a number, e.g., 123 is noted as 1:2:3, equivalent to the expanded form 100+20+3, distinguishing the hundreds, tens, and units.

The RealFlow Multiplier Algorithm (RFMA) consistently functions across its various components, following a left-to-right methodology. Its unique approach calculates processing steps by adding one to the multiplier's total digit count. A salient feature of RFMA is its capability to process all multiplicand digits concurrently, ensuring swift and streamlined multiplication, regardless of the number of digits involved. Within RFMA, right-shifting (One for a single-digit multiplicand or two for a two-digit multiplicand, like 11) decisions hinge on specific carry-related conditions. A shift is executed when both the current and preceding result lines either lack a carry or possess it. Contrarily, if the current result line has a carry but the previous doesn't, shifting is avoided. Prioritizing the unit digit and leveraging right shifts when apt, RFMA maintains both its efficacy and transparency.

In the multiplier processing of the RFMA, three distinct scenarios are present. In the first scenario, when the multiplier is just one digit, depicted as a, it serves both the beginning and end rules, making for a seamless transition from the start to the conclusion, aptly represented as (c=a). In the second scenario, when the multiplier extends to two digits, a and c, the middle section navigates with ‘a’ acting as the preceding digit (b₋₁=a) and ‘c’ as the current one (bₘ=c). The outer sections, both starting and concluding, individually cater to ‘a’ and ‘c’. The third and broadest scenario ensues when the multiplier spans multiple digits, commencing from ‘a’, meandering through the ‘bi’ digits, and culminating at ‘c’. Regardless of the active scenario, the computational steps consistently equate to the number of digits in the multiplier, augmented by one. A constant practice in the RFMA is to first carry over the tenth digit to the preceding result and subsequently affix the unit digit. Significantly, the maximum anticipated individual process outcome peaks at 23, specifically when the multiplicand digit value is three, denoted as (dv=3). This highlights that any carryover is strictly restricted to the values of 1 or 2.

The RFMA can concurrently run up to 13 algorithms, optimizing efficiency. When encountering repeated digit values, it copies outcomes from prior identical values. Its precision ensures that each digit is processed correctly, and as computations conclude, the RFMA integrates the unit digit while managing carryovers.

For multiplicands under eight (2<dv<8), relevant to algorithms RFMA-3 to RFMA-7, a unique method handles the rightmost half of a digit. If the previous digit (b₋₁) is odd, an added 5 ensures multiplication consistency and accuracy.

The RFMA method is structured around a series of specialized part-algorithms tailored for specific multiplicand values, as detailed in the table. This table serves as a comprehensive guide for the RFMA's methodology, facilitating users in quickly identifying the suitable part-algorithm for their multiplicand, ensuring precise and confident multiplication. The table's design not only offers clarity on each part-algorithm's workings but also emphasizes the RFMA's meticulous approach, reinforcing its commitment to providing an intuitive, efficient multiplication experience for users.

Table 8 summarizes all RFMA-parts rules. The multiplicand values are located in the first column on the left and multiplied by the multiplier sequences (a: bᵢ: c). The second row presents the three possible result sections. The first and last columns deal with a single digit, while the middle column handles two digits in each process step.

TABLE 8

| | a | bi | c | |
|---|---|---|---|---|
| * | The left digit= | Middle digits= | One's digit= | m |
| 12 | a | bi + 2 bi − 1 | 2c | 1 |
| 11 | a | bi + bi − 1 | c | 2 |
| 9 | a − 1 | bi + (9 − bi − 1) | 10 − c | 3 |
| 8 | a − 2 | bi + 2(9 − bi − 1) | 2(10 − c) | 4 |
| 7 | a/2 | bi/2 + 2 bi − 1 E | 2c E | 5 |
| | (a − 1)/2 | bi/2 + 2 bi − 1 + 5 O | 2c + 5 O | |
| 6 | a/2 | bi/2 + bi − 1 E | c E | 6 |
| | (a − 1)/2 | bi/2 + bi − 1 + 5 O | c + 5 O | |
| 5 | a/2 | bi/2 if bi − 1 E | 0 E | 7 |
| | (a − 1)/2 | bi/2 + 5 if bi − 1 O | 5 O | |
| 4 | (a/2) − 1 | bi/2 + 2(9 − bi − 1) E | 10 − c E | 8 |
| | (a − 1)/2 | bi/2 + 2(9 − bi − 1) + 5 O | 10 − c + 5 O | |
| 3 | (a/2) − 2 | bi/2 + 2(9 − bi − 1) E | 2(10 − c) E | 9 |
| | (a − 1)/2 | bi/2 + 2(9 − bi − 1) + 5 O | 2(10 − c) + 5 O | |
| 2 | a + a | bi + bi | c + c | 10 |

This table serves as calculation proof for all three mentioned scenarios. In the first scenario, especially when demonstrating how to convert a single multiplicand digit (2<dv<10) into two multiplicand digits, one should ignore the middle digits column and consider only the ‘a’ and ‘c’ columns. Row 6 in this table elucidates the intricate calculations and serves as an unequivocal proof of the efficacy and precision of the RFM-6a method. It clearly demonstrates how one can compute the multiplication between the number 6 and any singular integer digit without actually performing the multiplication.

### The RealFlow Multiplier—11 Method

The RFM-11 method is a revolutionary approach for multiplying numbers by 11. Instead of the traditional multiplication method which can often be tedious and time-consuming, the RFM-11 method leverages unique characteristics of the number 11 to provide swift calculations. It focuses on summing digits and their predecessors, eliminating the need for prolonged calculations, and offering a more intuitive method that can be applied in sequential fashion, making it an ideal candidate for real-time, responsive multiplication processes.

TABLE 9 serves as a tangible proof of the Lemma1 technique, detailing a methodical approach to multiplying numbers by 11 through the summation of successive digits, anchored by the distinct components (a, bᵢ, and c), the process commences with the leftmost digit, (a), being retained. Subsequent steps produce the summation of neighboring digits, revealing results such as (b₀+α), (b₁+b₀), and so on up to (bₘ+bₘ₋₁). In the culmination of this method, when the ⊗11 operation is applied to the original sequence, two critical representations emerge. The first is a sequential format, depicted as (a: bᵢ+bᵢ₋₁:c). Simultaneously, an alternate representation can be expressed in polynomial terms as

$$11 ⊗ ( a : bi : c ) = {10}^{m + 1} a + {\sum }_{i = 0}^{{i}_{m}} {10}^{m - i} ( {b}_{i} + {b}_{i - 1} ) + c$$

TABLE 9

| Number of steps | 1 | 2 | 3 | 4 | --------- | m + 1 | m + 2 |
|---|---|---|---|---|---|---|---|
| | 1 | 1 | | | | | |
| ${\to }_{\begin{matrix}c & {b}_{i} & a\end{matrix}}$ | a | a | | | | | |
| | | b₀ | b₀ | | | | |
| | | | b₁ | bᵢ₋₁ | | | |
| | | | | bᵢ | --------- | [symbol] | |
| | | | | | | bₘ₋₁ | |
| | | | | | | bₘ | c |
| Sum (2 ≤ \| ≤ m) | a | b₀ + a | b₁ + b₀ | bᵢ + bᵢ₋₁ | --------- | bₘ + bₘ₋₁ | c |

= a10^{m+1} + (b₀ + a) 10^{m} + (b₁ + b₀) 10^{m-1} + +(bₘ₋₁ + bₘ₋₂)10² + (c + bₘ₋₁)10 + c

| | | | | | |
|---|---|---|---|---|---|
| Sum (0 ≤ \| ≤ m) | a | bᵢ + bᵢ₋₁ | ----------------------------- | bₘ + bₘ₋₁ | c |

$11 ⊗ ( a : {b}_{i} : c ) = a : {b}_{i} + {b}_{i - 1} : c = {10}^{m + 1} a + {\sum }_{i = 0}^{{i}_{m}} {10}^{m - i} ( {b}_{i} + {b}_{i - 1} ) + c$

TABLE 10 illustrates the multiplication simple example of 11 by the number 72635452. Using the RFMA rule, which operates on pairs of adjacent digits, we start with the leftmost digit, which remains as it is. Then, we proceed by adding this digit to the one immediately to its right. For the first pair, 7 and 2, the sum is 7+2=9. For the next pair, which is 2 and 6, the sum is 2+6=8. Continuing this process for the entire number, while keeping the rightmost digit (2) unchanged at the end, we derive the result 798989972. This method highlights how, by pairing and adding adjacent digits of a number, one can efficiently compute the product of that number and 11.

TABLE 10

| | | | | | | | | | |
|---|---|---|---|---|---|---|---|---|---|
| 11 | x | 7 | 2 | 6 | 3 | 5 | 4 | 5 | 2 |

| | 7 | 7 + 2 = 9 | 2 + 6 = | 6 + 3 = | 3 + 5 = | 5 + 4 = | 4 + 5 = | 5 + 2 = | 2 |
|---|---|---|---|---|---|---|---|---|---|
| | | | 8 | 9 | 8 | 9 | 9 | 7 | |
| Result(add) | 7 | 9 | 8 | 9 | 8 | 9 | 9 | 7 | 2 |

TABLE 11 presents another multiplication example using 11 and the number 71935603. Applying the Lemma1 rule, which operates on pairs of adjacent digits, we first leave the leftmost digit unchanged. We then add this digit to its immediate neighbor on the right. For the initial pair, 7 and 1, the sum is 7+1=8. Moving to the next pair, 1 and 9, the sum is 1+9=10. As we progress through the number, the summing of adjacent digits yields a “Mid-result” of numbers. However, any sum that's a two-digit number requires carrying over.

Incorporating the carry, for the sum 10 from 1+9, 1 is carried to the left (making the previous 8 a 9), leaving 0 as the result for its position. Similarly, for the sum 12 from 9+3, 1 is carried to the left, adjusting the 0 to 1 and leaving 2 for its position. This pattern continues throughout. By the end, keeping the rightmost digit (3) unchanged, the Final result after considering the carry is 791291633. This example underscores the importance of the carry process when adding adjacent digits, especially when multiplying by 11.

TABLE 11

| | | | | | | | | | |
|---|---|---|---|---|---|---|---|---|---|
| 11 | x | 7 | 1 | 9 | 3 | 5 | 6 | 0 | 3 |

| | | | | | | | | | |
|---|---|---|---|---|---|---|---|---|---|
| Mid- | 7 | 7 + 1 = | 1 + 9 = | 9 + 3 = | 3 + 5 = | 5 + 6 = | 6 + 0 = | 0 + 3 = | 3 |
| result(add) | | 8 | 10 | 12 | 8 | 11 | 6 | 3 | |
| Final- | 7 | 9 | 1 | 2 | 9 | 1 | 6 | 3 | 3 |
| result(carry) | | | | | | | | | |

### The Real Flow Multiplier Algorithm-11

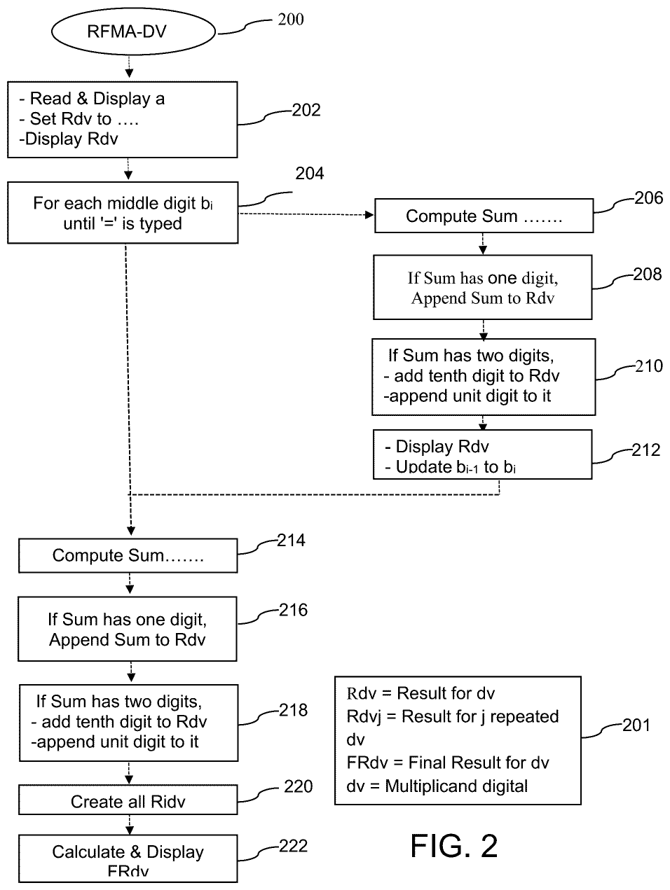

TABLE 12 illustrates the rules for the three RFMA-11 parts as shown in FIG. 2.: In box 202, the value R_{dv} is represented as a. For box 206, the result is the sum of the previous digit and the current digit. Meanwhile, the value in box 214 is denoted with a different sum.

TABLE 12

Box number

| | 202 | 206 | 214 |
|---|---|---|---|
| Rule | R11 = a | Sum = bᵢ₋₁ + bᵢ | Sum = c |

In TABLE 13, the RFMA-11 algorithm commences with the initial digit of the Input (Multiplier), 7, setting the starting point for the Output (Result). Subsequently, each digit in the Output (Result) row is determined by summing adjacent digits from the Input (Multiplier) and appending the unit digit of the sum. The sequence builds as follows: 7, 79, 798, 7989, 79893, 798934. When the algorithm encounters the pair 4 and 6, the sum is a two-digit number, 10. In this scenario, the tenth digit ‘1’ is added to the preceding result, 798934, and then the unit digit ‘0’ is appended, yielding 7989350. This step clearly demonstrates the RFMA-11 algorithm's approach to handling two-digit sums, by integrating the tenth digit into the existing result before appending the unit digit, ultimately obtaining 79893506 in the Output (Result) row.

TABLE 13

| | Input (Multiplier) | | | | | | | |
|---|---|---|---|---|---|---|---|---|
| | 7 | 2 | 6 | 3 | 0 | 4 | 6 | = |
| Output (Result) | 7 | 79 | 798 | 7989 | 79893 | 798934 | 7989350 | 79893506 |

### The RealFlow Multiplier—6 Method

The RFM-6 Method, an innovative derivative of the RFM-11 Method, introduces a unique twist in its computation. Rather than simply adding the full value of digits in each pair process as seen in its predecessor, the RFM-11, the RFM-6 Method incorporates the addition of half the value of the current digit (bi) to the previous one (bi−1). Moreover, given the multiplicand is 6, it becomes imperative to inspect each digit of the multiplier for its parity. If found odd, one should add 5 to the outcome. A significant advantage of the RFM-6 Method is its adaptability to unlimited multipliers, making it universally applicable. Additionally, its real-time processing capability ensures that computations are not only accurate but also swift, accommodating the demands of modern-day data operations.

TABLE 14 exemplifies the RFM-6a method in action, illustrating the precise calculations when the number 6 is multiplied with a single-digit integer. This table serves as tangible proof of the RFM-6a method's accuracy and adaptability for such computations.

TABLE 14

| Statement of the Problem: | $6 \times a \{ \begin{matrix}10 ( a / 2 ) + a = a / 2 : a if a E \\ 10 ( ( a - 1 ) / 2 ) + 2 a + 5 = ( a - 1 ) / 2 : a + 5 if a iO\end{matrix}$ | |
|---|---|---|
| Proof for: | Even a | Odd a |
| Represen- | 6 = 5 + 1 | 6 = 5 + 1 |
| tation of 6: | | |
| Distributive Property: | $\begin{matrix}6 \times a = ( 5 + 1 ) \times a \\ = 5 a + a\end{matrix}$ | $\begin{matrix}6 \times a = ( 5 + 1 ) \times a \\ = 5 a + a \\ = 5 a - 5 + a + 5\end{matrix}$ |
| Substitution: | = 10(a/2) + a | = 10(a − 1)/2) + a + 5 |

| | |
|---|---|
| Combina- tion: | $\{ \begin{matrix}10 ( a / 2 ) + a if a is E \\ 10 ( ( a - 1 ) / 2 ) + a + 5 if a is O\end{matrix} = int ( \frac{a}{2} ) : \{ \begin{matrix}a if a E \\ a + 5 if a O\end{matrix}$ |

TABLE 15 showcases the RFM-6b method at work, detailing the meticulous processes when multiplying the number 6

$$[ int ( \frac{dv}{2} ) : \{ \begin{matrix}dv if a is E \\ dv + 5 else\end{matrix} ]$$

with sequences denoted as (a: bᵢ: c), which can span from a single-digit integer (a) to an infinite string of digits. The table stands testament to the RFM-6b method's precision and its flexible adaptability across diverse computational scenarios. The table provides clear proof of the accuracy and adaptability inherent in the RFM-6b method across varied computational challenges.

TABLE 15

| Number of | | | | | |
|---|---|---|---|---|---|
| steps | 1 | 2 | --------- | m + 1 | m + 2 |
| | $int ( \frac{dv}{2} )$ | $\{ \begin{matrix}dv if a is E \\ dv + 5 else\end{matrix}$ | | | |
| ${\to }_{\begin{matrix}c & {b}_{i} & a\end{matrix}}$ | $int ( \frac{a}{2} )$ | $\{ \begin{matrix}{b}_{i - 1} if {b}_{i - 1} is E \\ {b}_{i - 1} + 5 else\end{matrix}$ | | | |
| | | $int ( \frac{{b}_{i}}{2} )$ | | | |
| | | | --------- | [symbol] | |
| | | | | $\{ \begin{matrix}{b}_{m - 1} if {b}_{m - 1} is E \\ {b}_{m - 1} + 5 else\end{matrix}$ | |
| | | | | $int ( \frac{{b}_{m}}{2} )$ | |
| Sum ( 0 ≤ \| ≤ m) | $int ( \frac{a}{2} )$ | $int ( \frac{{b}_{i}}{2} ) + \{ \begin{matrix}{b}_{i - 1} if {b}_{i - 1} is E \\ {b}_{i - 1} + 5 else\end{matrix}$ | | $int ( \frac{{b}_{m}}{2} ) + \{ \begin{matrix}{b}_{m - 1} if {b}_{i - 1} is E \\ {b}_{m - 1} + 5 else\end{matrix}$ | $\{ \begin{matrix}c if c is E \\ c + 5 else\end{matrix}$ |

$= int ( \frac{a}{2} ) : int ( \frac{{b}_{i}}{2} ) + \{ \begin{matrix}{b}_{i - 1} if {b}_{i - 1} is E \\ {b}_{i - 1} + 5 else\end{matrix} : \{ \begin{matrix}c if c is E \\ c + 5 else\end{matrix} = {10}^{m + 1} int ( \frac{a}{2} ) + {\sum }_{i = 0}^{{i}_{m}} {10}^{m - i} [ int ( \frac{{b}_{i}}{2} ) + \{ \begin{matrix}{b}_{i - 1} if {b}_{i - 1} is E \\ {b}_{i - 1} + 5 else\end{matrix} ] + \{ \begin{matrix}c if c is E \\ c + 5 else\end{matrix}$

TABLE 16 provides a clear illustration example of the RFM-6 multiplication method in practice. Utilizing the RFM-6 example, the table demonstrates the nuanced computation process when the number 6 is multiplied across a sequence of digits: 6, 4, 6, 2, 0, and 1. The results, presented as sequence 3, 8, 7, 7, 2, 0, 6, underline the method's accuracy. This example is particularly straightforward as it does not involve any carryover.

TABLE 16

| | | | | | | | |
|---|---|---|---|---|---|---|---|
| 6 | x | 6 | 4 | 6 | 2 | 0 | 1 |

| | | | | | | | |
|---|---|---|---|---|---|---|---|
| rule | 6/2 = | (6 + 4/2) = | (4 + 6/2) = | (6 + 2/2) = | (2 + 0) = | (0 + 1/2) = | (5 + 1) = |
| | 3 | 8 | 7 | 7 | 2 | 0 | 6 |
| result | 3 | 8 | 7 | 7 | 2 | 0 | 6 |

TABLE 17 exemplifies a deeper dive into the RFM-6 multiplication method using the ZMC-6 example. In this table, the multiplication of 6 with the sequence 3, 2, 7, 9, 0, 1 is showcased. The intricate computation process is evident as the number 6 interacts with digits in the sequence, producing intermediary results such as

$$[ 5 + 3 + \frac{2}{2} = 9 ] , and 5 + 7 + \frac{9}{2} = 16.5 ]$$

rounded down to 16. The final result emerges as the sequence 1, 9, 6, 7, 4, 0, 6, which is consistent with the expected outcome. This table not only highlights the accuracy of the RFM-6 method but also offers a transparent view into its decimal handling and internal calculations.

TABLE 17

| | | | | | | | |
|---|---|---|---|---|---|---|---|
| 6 | x | 3 | 2 | 7 | 9 | 0 | 1 |

| | | | | | | | |
|---|---|---|---|---|---|---|---|
| rule | 3/2 = | (5 + 3 + | (2 + | (5 + 7 + | (5 + 9 + | (0 + | (5 + 1) = |
| | 1 | 2/2) = 9 | 7/2) = 5 | 9/2) = 16 | 0/2) = 14 | 1/2) = 0 | 6 |
| result | 1 | 9 | 6 | 7 | 4 | 0 | 6 |

### RealFlow Multiplier Algorithm-6

In TABLE 18, the algorithm outlines a process involving three primary rules. Firstly, the value in box 202 R6 is updated through integer division of a by 2. Secondly, at the 206 mark, the sum is derived from the previous value (bᵢ₋₁) added to the integer half of current value (bᵢ). If (bᵢ₋₁) is even, this is the sum; however, if (bᵢ₋₁) is odd, an extra 5 is included. Lastly, at 214, c is appended to R6. If c is even, it's added as is, but if odd, it's incremented by 5 before appending to R6.

TABLE 18

| Box | | | |
|---|---|---|---|
| number | ln 202 | ln 206 | ln 214 |
| Rule | $R 6 = int ( \frac{a}{2} )$ | $\begin{matrix}Sum = int ( \frac{{b}_{i}}{2} ) + \\ \{ \begin{matrix}{b}_{i - 1} if {b}_{i - 1} is E \\ {b}_{i - 1} + 5 else\end{matrix}\end{matrix}$ | $Sum = \{ \begin{matrix}c if c is E \\ c + 5 else\end{matrix}$ |

TABLE 19 gives the RFMA-6 algorithm's methodology example, we can trace the transformation of the Input (Multiplier) to the Output (Result). The algorithm begins its computation with the initial multiplier digit, 6, producing an initial result of 3. Moving to the subsequent digit, 4, it calculates a sum by adding the current digit to half of the previous digit, (sum=6+4/2=8). This value is then appended to the previous result, resulting in 38. Similarly, for the next digit, 2, the sum becomes (sum=4+2/2=5), yielding an output of 385. When we reach the digit 7, since the preceding number, 0, is even, the calculation involves (sum=0+int (7/2)=3), Producing an output of 38523. However, for the next digit, 2, given that 7 is odd, an additional 5 is added to the sum: (sum=5+7+2/2=13). In this instance, the 1 from 13 is added to the prior output, 38523, resulting in 38524, followed by appending the 3 to produce 385243.

Continuing with the same methodology, the subsequent values are deduced, culminating in the final result, 38524338, after processing all input digits.

TABLE 19

| | Input (Multiplier) | | | | | | | |
|---|---|---|---|---|---|---|---|---|
| | 6 | 4 | 2 | 0 | 7 | 2 | 3 | = |
| Output (Result) | 3 | 38 | 385 | 3852 | 38523 | 385243 | 3852433 | 38524338 |

### RealFlow Multiplier—12 Method

The RFM-12 approach is a specialized algorithm optimized for multiplying any given number by 12. Built upon the principles of RFM-12, this approach seeks to enhance computational efficiency by leveraging the unique properties of the number 12. Unlike traditional multiplication methods, RFM-12 breaks down the input number digit by digit, systematically processing each one in the context of the overarching multiplication goal.

TABLE 20 offers a detailed exposition of the RFM-12 rule, showcasing a methodical procedure for multiplying numbers by 12. The technique centers on interacting with consecutive digits. Specifically, one digit is doubled and then summed with its immediate neighbor. The process distinctly identifies each digit using the components (a, bᵢ, and c). The operation begins with the leftmost digit, a, standing unchanged. The subsequent procedure yields a result by doubling a digit and then adding

TABLE 20

| Number of steps | 1 | 2 | 3 | 4 | ---------- | m + 1 | m + 2 |
|---|---|---|---|---|---|---|---|
| ${\to }_{\begin{matrix}c & {b}_{i} & a\end{matrix}}$ | 1 a | 2 2a | | | | | |
| | | b₀ | 2b₀ | | | | |
| | | | b₁ | 2bᵢ₋₁ | | | |
| | | | | bᵢ | ---------- | | |
| | | | | | | $\begin{matrix}2 {b}_{m - 1} \\ {│}_{{│}_{│}} \\ {b}_{m}\end{matrix}$ | 2c |
| Sum (2 ≤ \| ≤ m) | a | b₀ + 2a | b₁ + 2b₀ | bᵢ + 2bᵢ₋₁ | ---------- | bₘ + 2bₘ₋₁ | 2c |

a10^{m+1} + (b₀ + 2a) 10^{m} + (b₁ + 2b₀) 10^{m-1} + I + (bₘ₋₁ + 2bₘ₋₂)10² + (c + 2bₘ₋₁)10 + 2c

| | | | | | |
|---|---|---|---|---|---|
| Sum (0 ≤ \| ≤ m) | a | bᵢ + 2bᵢ₋₁ | --------------------------------- | bₘ + 2bₘ₋₁ | 2c |

$12 ⊗ ( a : {b}_{i} : c ) = a : {b}_{i} + 2 {b}_{i - 1} : 2 c = {10}^{m + 1} a + {\sum }_{i = 0}^{{i}_{m}} {10}^{m - i} ( {b}_{i} + 2 {b}_{i - 1} ) + 2 c$

it to its succeeding digit, generating outcomes such as (b₀+2α), (b₁+2b₀), continuing in this manner until (bₘ+2bₘ₋₁). At the conclusion of this methodology, there are two essential representations are produced. The first is a sequential format, represented as (a: bᵢ+2bᵢ₋₁: 2c). Concurrently, another depiction is provided in polynomial notation as:

$$[ {10}^{m + 1} a + {\sum }_{i = 0}^{{i}_{m}} {10}^{m - i} ( {b}_{i} + 2 {b}_{i - 1} ) + 2 c ]$$

TABLE 21 details the application's simple example of the RFM-12 rule when multiplying by 12. Using the number 32,041,402 as a demonstration, the method starts by leaving the leftmost digit, 3, as is. Next, this digit is doubled and combined with the subsequent digit, 2, yielding 8. The process persists in this manner: the digit 2 is doubled, and the following digit, 0, is added, producing 4. As the procedure progresses, we encounter calculations like 2×2+0=4 and 2×4+1=9. For the final digit on the right, only doubling takes place. Notably, there are no carryovers in this example. Applying this structured approach to 32,041,402 when multiplied by 12 gives us the product 384,496,824.

TABLE 21

| | | | | | | | | | |
|---|---|---|---|---|---|---|---|---|---|
| 12 | x | 3 | 2 | 0 | 4 | 1 | 4 | 0 | 2 |

| | | | | | | | | | |
|---|---|---|---|---|---|---|---|---|---|
| Rule (duple & | 3 | 2 × 3 + | 2 × 2 + | 2 × 0 + | 2 × 4 + | 2 × 1 + | 2 × 4 + | 2 × 0 + | 2 × |
| add) | | 2 = 8 | 0 = 4 | 4 = 4 | 1 = 9 | 4 = 6 | 0 = 8 | 2 = 2 | 2 = 4 |
| Final result | 3 | 8 | 4 | 4 | 9 | 6 | 8 | 2 | 4 |

TABLE 21 showcases another application example of the RFM-12 rule, this time for multiplying by 12. Using the number 41,816,003 as our example, the method begins by keeping the leftmost digit, 4, in its original form. The next calculation doubles 4 and adds 1, resulting in 9. Doubling 1 and combining it with 8 yields 10, carrying over the 1 to the previous result. This carried 1 is added to 9 (making it 0 and carrying over the 1 to 4), then double the 8 and further combined with 1, leading to 17. Hence, 7′ occupies that position, and another 1 is carried over to the previous result. Continuing in this manner, 1 is doubled and combined with 6 to form 8. The subsequent digits involve straightforward doubling: 6 becomes 12, carrying the 1 over to the previous result, and the zeros stay unchanged post-doubling. Finally, 3 is doubled to arrive at 6. After accounting for all carryovers, the product of 41,816,003 multiplied by 12 is 501,792,036.

TABLE 21

| | | | | | | | | | |
|---|---|---|---|---|---|---|---|---|---|
| 12 | x | 4 | 1 | 8 | 1 | 6 | 0 | 0 | 3 |

| | | | | | | | | | |
|---|---|---|---|---|---|---|---|---|---|
| Rule (duple & | 4 | 2*4 + | 2*1 + | 2*8 + | 2*1 + | 2*6 + | 2*0 + | 2*0 + | 2*3 = |
| add) | | 1 = 9 | 8 = 10 | 1 = 17 | 6 = 8 | 0 = 12 | 0 = 0 | 3 = 3 | 6 |
| Final result | 5 | 0 | 1 | 7 | 9 | 2 | 0 | 3 | 6 |

### The RealFlow MultiplierAlgorithm-12

How RFMA-12 Works: The RFMA-12 method initiates by prompting the user to input the digits of the number they intend to multiply. As each digit is input, the algorithm gets to work, focusing on the sum of the current digit and twice its preceding digit. This cumulative approach streamlines the multiplication process, emphasizing immediacy and clarity with every step. If one visualizes the multiplication process as a cascade of operations, the RFMA-12 method serves as the efficient guide, directing the flow seamlessly until the last digit is processed. The final result is a number that is an exact product of the original input and 12.

TABLE 22 depicts the rules specific to RFMA-12 flowchart: In box 202, the value Ra is represented as ‘a’. For box 206, the result is calculated as the sum of twice the previous digit added to the current digit. Meanwhile, in box 214, the sum is denoted as ‘2c’, as highlighted in FIG. 3.

TABLE 22

Box number

| | 202 | 206 | 214 |
|---|---|---|---|
| Rule | R12 = a | Sum = 2bᵢ₋₁ + bᵢ | Sum = 2c |

In TABLE 23, the RFMA-12 algorithm example, the computation begins with the first digit of the Input (Multiplier), 3, setting the initial Output (Result) as 3. Proceeding to the next digit, 2, the algorithm doubles the first digit (3×2) and adds the current digit (2), generating 8, which is then appended to form 38 in the Output (Result) row. The sequence progressively builds with this logic: 384, 3844, 38449, reaching 384500 when handling the two-digit result from 2×1+8. The tens digit ‘1’ is added to the existing result, 38449, creating a carry-over and evolving the sequence to 38450. Finally, the ‘0’ is appended, leading to 384500. Similar with the digits 8 and 1, where 2×8+1 results in 17. The first digit, 1, is added to the prior result 384500, and then 7 is appended, leading to 3845017. Finally, when “=” is inputted, the algorithm processes it by doubling the last digit in the Input (Multiplier), which is 1, and appending the result, forming the final Output (Result) as 38450162. This illustrates the RFMA-12 algorithm's nuanced approach in sequence building, highlighting its adept handling of intermediate and final steps.

TABLE 23

| | Input (Multiplier) | | | | | | | |
|---|---|---|---|---|---|---|---|---|
| | 3 | 2 | 0 | 4 | 1 | 8 | 1 | = |
| Output (Result) | 3 | 38 | 384 | 3844 | 38449 | 384500 | 3845017 | 38450162 |

### The RealFlow Multiplier Method-7

TABLE 24 meticulously illustrates the RFMA-7b approach, focusing on situations where the multiplicand, instead of being the fixed number 7, is a two-digit integer. This depiction underscores the steps involved when using a two-digit integer in multiplication, all while bypassing the conventional multiplication procedure. The table acts as solid proof, emphasizing the precision and adaptability of the RFMA-7b method when dealing with these expanded scenarios, thereby solidifying the efficacy of our newly invented RFMA-7.

TABLE 24

| Statement of the Problem: | $7 \times a \{ \begin{matrix}10 ( a / 2 ) + 2 a = a / 2 : 2 a if a is E \\ 10 ( ( a - 1 ) / 2 ) + 2 a + 5 = ( a - 1 ) / 2 : 2 a + 5 if a is O\end{matrix}$ | |
|---|---|---|
| Proof for: | Even a | Odd a |
| Representation of 7: | 7 = 5 + 2 | 7 = 5 + 2 |
| Distributive Property: | $\begin{matrix}7 \times a = ( 5 + 2 ) \times a \\ = 5 a + 2 a\end{matrix}$ | $\begin{matrix}7 \times a = ( 5 + 2 ) \times a \\ = 5 a + 2 a \\ = 5 a - 5 + 2 a + 5\end{matrix}$ |
| Substitution: | = 10(a/2) + 2a | = 10((a − 1)/2) + 2a + 5 |

| | |
|---|---|
| Combination: | $= \{ \begin{matrix}10 ( a / 2 ) + 2 a = a / 2 : 2 a if a is an E \\ 10 ( ( a - 1 ) / 2 ) + 2 a + 5 = ( a - 1 ) / 2 : 2 a + 5 if a is O\end{matrix}$ |

For a multiplication operation between the sequence a: bᵢ: c and 7, a systematic pattern, as outlined by our lemma, surfaces. Starting with the most significant digit a, the initial interaction divides it by 2 and multiplies the floor value by 10^{m+1}, establishing its position. As we delve into the intermediate digits by, each undergoes a transformation wherein its product is shaped by the integer division of bᵢ, by 2, combined with twice the value of bᵢ₋₁. Depending on whether bᵢ₋₁ is even, its value remains, but if odd, an additional 5 is incorporated. This result, taking its positional value into account, is then multiplied by 10^{m-i}. Lastly, the least significant digit c) gets doubled if even, with an added 5 if odd. The intricate details of this multiplication, as guided by the RFM-7a, offers an illuminating insight into the profound intricacies of positional arithmetic, and can be further explored in Table 25.

TABLE 26 meticulously demonstrates the workings of the RFM-7b approach, shedding light on the nuanced process of multiplying a two-digit integer, 7, with the number 241,201. This table elucidates the complexities and innovation behind this method, bypassing traditional multiplication techniques.

TABLE 25

| Number of | | | | | |
|---|---|---|---|---|---|
| steps | 1 | 2 | ---------- | m + 1 | m + 2 |
| ${\to }_{\begin{matrix}c & {b}_{i} & a\end{matrix}}$ | $int ( \frac{dv}{2} )$ $int ( \frac{a}{2} )$ | $2 \{ \begin{matrix}2 dv if a is E \\ 2 dv + 5 else\end{matrix}$ $\{ \begin{matrix}2 {b}_{i - 1} if {b}_{i - 1} is E \\ 2 {b}_{i - 1} + 5 else\end{matrix}$ | | | |
| | | $int ( \frac{{b}_{i}}{2} )$ | | | |
| | | | ----------- | ------ [symbol] | |
| | | | | $2 \{ \begin{matrix}{b}_{m - 1} if {b}_{m - 1} is E \\ {b}_{m - 1} + 5 else\end{matrix}$ | |
| | | | | $int ( \frac{{b}_{m}}{2} )$ | |
| Sum (0 ≤ \| ≤ m) | $int ( \frac{a}{2} )$ | $int ( \frac{{b}_{i}}{2} ) + \{ \begin{matrix}2 {b}_{i - 1} if {b}_{i - 1} is E \\ 2 {b}_{i - 1} + 5 else\end{matrix}$ | | $int ( \frac{{b}_{m}}{2} ) + \{ \begin{matrix}2 {b}_{m - 1} if {b}_{i - 1} is E \\ 2 {b}_{m - 1} + 5 else\end{matrix}$ | $\{ \begin{matrix}2 c if c is E \\ 2 c + 5 else\end{matrix}$ |

$= int ( \frac{a}{2} ) : int ( \frac{{b}_{i}}{2} ) + \{ \begin{matrix}2 {b}_{i - 1} if {b}_{i - 1} is E \\ 2 {b}_{i - 1} + 5 else\end{matrix} : \{ \begin{matrix}2 c if c is E \\ 2 c + 5 else\end{matrix} = {10}^{m + 1} int ( \frac{a}{2} ) + {\sum }_{i = 0}^{{i}_{m}} {10}^{m - i} [ int ( \frac{{b}_{i}}{2} ) + 2 \{ \begin{matrix}{b}_{i - 1} if {b}_{i - 1} is E \\ {b}_{i - 1} + 5 else\end{matrix} ] + \{ \begin{matrix}2 c if c is E \\ 2 c + 5 else\end{matrix}$

Beginning with the leftmost digit 2, the operation divides it by 2, yielding a result of 1. Moving on to the next digit, 4, the technique doubles the prior result 1, and adds half of 4 to it. Since 2 is even, we don't add 5, and the outcome becomes 6. Continuing with this pattern, for the digit 1, we double 4, add it to half of 1, and considering 4 is even, no additional 5 is added, leading to a result of 8. The procedure for 2 entails doubling 1, adding it to half of 2, and once again, since 1 is odd, adding 5 to the product, culminating in 8.

Adhering to this systematic approach, when processing the digit ‘0’, the operation doubles 2, adds it to half of 0, and, as 2 is even, doesn't incorporate an additional 5, resulting in 4. The penultimate digit, 1, doubles 0 and adds it to half of 1, and since 0 is even, the outcome is 0. Lastly, for the final digit ‘1’, the operation simply doubles it to produce 2 and add 5 because 1 is odd.

Conclusively, through the lens of RFM-4b and its structured methodology, the multiplier 241,201 and the multiplicand 7 converge to produce the sum 1,688,407.

TABLE 26

| | | | | | | | |
|---|---|---|---|---|---|---|---|
| 7 | x | 2 | 4 | 1 | 2 | 0 | 1 |

| | | | | | | | |
|---|---|---|---|---|---|---|---|
| rule | 2/2 = 1 | (2 × 2 + | (2 × 4 + | (5 + 2 × 1 + | (2 × 2 + | (2 × 0 + | (5 + 2 × |
| | | 4/2) = 6 | 1/2) = 8 | 2/2) = 8 | 0) = 4 | 1/2) = 0 | 1) = 7 |
| result | 1 | 6 | 8 | 8 | 4 | 0 | 7 |

TABLE 27 presents a concise overview of the RFM-7 technique, illustrating the steps to multiply the integer 7 with 241,851. This table differentiates itself from standard multiplication methods by using a unique approach. Starting with the first digit ‘2’, we divide it by 2, giving us 1. For the next digit 4, we double our previous digit 2 and add half of 4, resulting in 6. Moving on to the digit 1, the operation doubles 4, adds half of 1, providing an outcome of 8. For the digit 8, the procedure involves doubling 1 (adding 5 since 1 is odd) and adding half of 8, resulting in 11 where our carry-over mechanism comes into play. The subsequent digit 5, we double the 8 and add half of 5, leading to 18. We add the tens place of this result (1) to the previous 1, obtaining 2. We then consider the units place of the outcome, making it 8. For the next digit 1, we double 5, add half of 1 and adding 5 since 5 is odd, and arrive at 15. Using the tens place, 1, and adding it to the previous result 8, we obtain 9, appending the units place 5 to get 5. This process continues for all digits. Whenever a two-digit sum emerges, we use its tens digit for carry-over to ensure precision. The result of multiplying 7 by 241,851 using the RFM-7 method, as detailed in Table 20, is 1,692,957, illustrating the technique's accuracy and unique approach.

TABLE 27

| | | | | | | | |
|---|---|---|---|---|---|---|---|
| 7 | x | 2 | 4 | 1 | 8 | 5 | 1 |

| | | | | | | | |
|---|---|---|---|---|---|---|---|
| rule | 2/2 = 1 | (2*2 + | (2*4 + | (5 + 2*1 + | (2*8 + | (5 + 2*5 + | (5 + |
| | | 4/2) = 6 | 1/2) = 8 | 8/2) = 11 | 5/2) = 18 | 1/2) = 15 | 2*1) = 7 |
| result | 1 | 6 | 9 | 2 | 9 | 5 | 7 |

### RealFlow Multiplier Algorithm-7

In TABLE 28, the procedure outlines specific rules for calculations. Initially, in box 202 R7, a value is updated using integer division of a by 2. At the step labeled 306, the sum is determined by (bᵢ₋₁) added to the integer half of (2bᵢ), but if the previous digit (bᵢ₋₁) is even, an additional 5 is added if (bᵢ₋₁) is odd. At 214, Update the sum as 2c if c is even, or calculate the sum of 5 and 2c if c is odd.

TABLE 28

| Box | | | |
|---|---|---|---|
| number | ln 202 | ln 206 | ln 214 |
| Rule | $R 7 = int ( \frac{a}{2} )$ | $\begin{matrix}Sum = int ( \frac{{b}_{i}}{2} ) + \\ \{ \begin{matrix}2 {b}_{i - 1} if {b}_{i - 1} is E \\ 2 {b}_{i - 1} + 5 else\end{matrix}\end{matrix}$ | $Sum = \{ \begin{matrix}2 c if c is E \\ 2 c + 5 else\end{matrix}$ |

TABLE 29 provides a thorough insight into an inventive multiplication algorithm, showcasing the sequential multiplication of an undisclosed number with the input multiplier sequence: 2, 4, 1, 2, 0, 2, and 7, employing an RFMA-7 method distinct from conventional multiplication approaches. The process begins with the first digit 2, divided by 2, yielding 1. Proceeding to 4, doubling the previous digit 2 and adding half of 4 provides 6, creating a cumulative result of 16. When the digit 1 is considered, the methodology doubles the preceding 4 and adds half of 1, producing 8, updating the running total to 168. Addressing the next digit 2, doubling the former 1 and adding half of 2 results in 3; however, since the preceding digit is odd, an additional 5 is added, evolving the total to 1688. The process encounters a zero in the sequence, where the prior 2 is doubled and added to half of 0, maintaining the cumulative result at 16884. For the next digit 2, doubling the 0 and adding half of 2 produces 1, extending the outcome to 168841. Approaching the final digit 7, doubling the previous 2 and adding half of 7 would typically result in 7; however, since 7 is odd, the result becomes 19. The tens place 1 is incorporated into the preceding total, updating it to 1688418, and the units place 9 is appended to finalize the result as 16884189. Table 29 proficiently navigates through the method's complexities, particularly highlighting the carry-over mechanism when sums extend beyond a single digit, thereby illustrating the algorithm's precision and introducing a novel viewpoint towards multiplication processes.

TABLE 29

| | Input (Multiplier) | | | | | | | |
|---|---|---|---|---|---|---|---|---|
| | 2 | 4 | 1 | 2 | 0 | 2 | 7 | = |
| Output (Result) | 1 | 16 | 168 | 1688 | 16884 | 168841 | 1688417 | 16884189 |

### The RealFlow Multiplier—10 Method

TABLE 30 demonstrates an RFM-10 method. In the initial stages, the result R₁₀ is set to the first digit, a. As the method progresses, each subsequent digit, denoted as (bi), is appended to R₁₀, building upon the previous outcome. Once the ‘=’ symbol is inputted, a ‘0’ is appended to R₁₀, signifying the conclusion of the multiplication process. In this modified RFMA-10 method, when applying general rules that support rule 5, the previous digit is zeroed out, and the current digit is added. This simplification streamlines rule application by focusing on the current digit's contribution while nullifying the impact of the previous digit.

TABLE 30

| Number of steps | 1 | 2 | 3 | 4 | --------------- | m + 1 | m + 2 |
|---|---|---|---|---|---|---|---|
| ${\to }_{\begin{matrix}c & {b}_{i} & a\end{matrix}}$ | 1 a | 0 0 | | | | | |
| | | b₀ | 0 | | | | |
| | | | b₁ | 0 | | | |
| | | | | bᵢ | ---------------- | [symbol] | |
| | | | | | | 0 | |
| | | | | | | c | 0 |
| Sum (2 ≤ \| ≤ m) | a | b₀ | b₁ | bᵢ | ---------------- | C | 0 |

= a10^{m+1} + (b₀) 10^{m} + (b₁) 10^{m-1} + I + (bₘ₋₁) 10² + (c)10 + 0

| | | | | | |
|---|---|---|---|---|---|
| Sum (0 ≤ \| ≤ m) | a | bᵢ | ----------------------- | C | 0 |

$10 ⊗ ( a : {b}_{i} : c ) = a : {b}_{i} : 0 = 1 {0}^{m + 1} a + {\sum }_{i = 0}^{{i}_{m}} 1 {0}^{m - i} ( {b}_{i} ) + 0$

TABLE 31 illustrates the utilization of the RFM-10 method in a stepwise manner. Beginning with R₁₀ initialized to a particular value, denoted as ‘a’, each subsequent digit, represented by (bi), is appended to R₁₀ in a sequential order. This process of appending continues cohesively until the ‘=’ symbol emerges. Upon encountering ‘=’, a ‘0’ is strategically appended to R₁₀.

TABLE 31

| | | | | | | | | | |
|---|---|---|---|---|---|---|---|---|---|
| 10 | x | 7 | 2 | 6 | 3 | 5 | 4 | 5 | 2 |

| | | | | | | | | | |
|---|---|---|---|---|---|---|---|---|---|
| Rule | 7 | 2 | 6 | 3 | 5 | 4 | 5 | 2 | 0 |
| Result(copy) | 7 | 2 | 6 | 3 | 5 | 4 | 5 | 2 | 0 |

### RealFlow Multiplier Algorithm-10

TABLE 32 showcases the guidelines governing the three components of RFMA-10. In box 202, the value termed as R₁₀ is exemplified by ‘a’. In box 206, the outcome is defined by the equation sum=current digit. On the other hand, the value encapsulated in box 214 is distinctly identified with a sum=0, as explicitly depicted in FIG. 3.

TABLE 32

Box number

| | 202 | 206 | 214 |
|---|---|---|---|
| Rule | R10 = a | Sum = bᵢ | Sum = 0 |

### The RealFlow Multiplier Method-5

TABLE 33 meticulously illustrates the Lemma5a approach, spotlighting scenarios where the multiplicand, traditionally a single-digit like 5, is transposed to a two-digit format. This depiction delineates the nuances involved when converting a one-digit integer like 5 into its two-digit form, deviating from standard multiplication practices. The table stands as compelling evidence, underscoring the capability to transition the one-digit multiplicand 5 for utilization in the RFMA-5 technique, thus reinforcing the effectiveness of this innovative method.

TABLE 33

| Statement of the Problem: | $5 \times a = int ( \frac{a}{2} ) : \{ \begin{matrix}0 & if a is an even number \\ 5 & if a is an odd number\end{matrix}$ | |
|---|---|---|
| Proof for: | Even a | Odd a |
| Representation of 5: | 5 = 5 + 0 | 5 = 5 + 0 |
| Distributive | 5 × a = (5 + 0) × a | 5 × a = (5 + 0) × a |
| Property: | = 5a | = 5a |
| | | = 5a − 5 + 5 |
| Substitution: | = 10(a/2) | = 10((a − 1)/2) + 5 |

| | |
|---|---|
| Combination: | $= int ( \frac{a}{2} ) : \{ \begin{matrix}0 & if a is an even number \\ 5 & if a is an odd number\end{matrix}$ |

TABLE 34 meticulously serves as proof, delineating the intricacies of a RFM-5 method rooted in base 5 arithmetic. The journey begins by setting the result R5 through the integer division of the initial digit ‘a’ by 2. As the method unfolds, the ensuing digit (bᵢ) is calculated by taking half of the current digit. The process pays close attention to the precedent

TABLE 34

| Number of steps | 1 | 2 | ------------ | m + 1 | m + 2 |
|---|---|---|---|---|---|
| ${\begin{matrix}c & {b}_{i} & a\end{matrix}}^{⟶}$ | $int ( \frac{dv}{2} )$ | $\{ \begin{matrix}0 & if {b}_{i} is E \\ 5 & else\end{matrix}$ | | | |
| | $int ( \frac{a}{2} )$ | $\{ \begin{matrix}0 & if {b}_{i - 1} is E \\ 5 & else\end{matrix}$ | | | |
| | | $int ( \frac{{b}_{i}}{2} )$ | | | |
| | | | ------------- | [symbol] | |
| | | | | $\{ \begin{matrix}0 & if {b}_{m - 1} is E \\ 5 & else\end{matrix}$ | |
| | | | | $int ( \frac{{b}_{m}}{2} )$ | |
| Sum (0 ≤ I ≤ m) | $int ( \frac{a}{2} )$ | $int ( \frac{{b}_{i}}{2} ) + \{ \begin{matrix}0 & if {b}_{i - 1} is E \\ 5 & else\end{matrix}$ | | $int ( \frac{{b}_{m}}{2} ) + \{ \begin{matrix}0 & if {b}_{i - 1} is E \\ 5 & else\end{matrix}$ | $\{ \begin{matrix}0 & if c is E \\ 5 & else\end{matrix}$ |

$= int ( \frac{a}{2} ) : int ( \frac{{b}_{i}}{2} ) + \{ \begin{matrix}0 & if {b}_{i - 1} is E \\ 5 & else\end{matrix} : \{ \begin{matrix}0 & if c is E \\ 5 & else\end{matrix} = {10}^{m + 1} int ( \frac{a}{2} ) + {\sum }_{i = 0}^{{i}_{m}} {10}^{m - i} [ int ( \frac{{b}_{i}}{2} ) + \{ \begin{matrix}0 & if {b}_{i - 1} is E \\ 5 & else\end{matrix} ] : \{ \begin{matrix}0 & if c is E \\ 5 & else\end{matrix}$

digit: should it be even; the current digit is directly appended to R₅. Conversely, if it's odd, a 5 is added to the current digit (bᵢ). If this operation yields a two-digit sum, the tens digit, typically ‘1’, is added to the current value of R₅, before appending the unit's digit. The culmination of the RFM-5 approach is marked by the presence of the ‘=’ symbol. At this juncture, the method scrutinizes the last digit, referred to as c. If even, a ‘0’ is appended to R₅, but if odd, a ‘5’ joins the concluding result. Table 24 stands as a testament to the precision of base 5 multiplication, accentuating the pivotal role played by each digit's predecessor in shaping its resultant value.

TABLE 35 offers a detailed application example of the RFM-5 method as previously outlined. Commencing with the lead digit 6 of the multiplier, it is divided by 2, which results in an initial output of 3. When the procedure moves to the digit 4, a straightforward halving renders 2, which naturally becomes the succeeding segment of our evolving result. Transitioning to the subsequent digit 6, its division by 2 gives 3, seamlessly extending our cumulative result. Approaching the digit 2, its halving procures a 1. With the ensuing digit 3, the halving operation provides 1.5. As only whole numbers are under consideration, this rounds down to 1. However, given that the antecedent digit 3 is odd, an additional 5 is integrated, leading to a summative value of 6 that gets appended to our result. The method draws to a close with the appearance of the ‘=’ sign, which triggers the addition of a 5 to the resultant sequence, a consequence of the last digit's oddness. This marks the ultimate outcome of the procedure, as visually represented in Table 35, resulting in the sequence ‘3, 2, 3, 1, 1, 5, 5’.

TABLE 35

| | | | | | | | |
|---|---|---|---|---|---|---|---|
| 5 | x | 6 | 4 | 6 | 2 | 3 | 1 |

| | | | | | | | |
|---|---|---|---|---|---|---|---|
| rule | 6/2 = 3 | (4/2) = 2 | (6/2) = 3 | (2/2) = 1 | (3/2) = 1 | (5 + 1/2) = 5 | 5 |
| result | 3 | 2 | 3 | 1 | 1 | 5 | 5 |

### Real Flow Multiplier Algorithm-5

TABLE 36 elucidates the protocols directing the three elements associated with RFMA-10. In box number 202, the parameter denoted as R₅ is characterized by a/2. For box 206, the resulting computation is depicted by the formula

$$sum = int ( \frac{{b}_{i}}{2} ) + [ 0 if {b}_{i - 1} is E ;$$

5 otherwise]. Conversely, in box 214, the value is determined by the rule sum=[0 if c is E; 5 otherwise], as lucidly presented in FIG. 2.

TABLE 36

| Box | | | |
|---|---|---|---|
| number | 202 | 206 | 214 |
| Rule | R5 = a/2 | $Sum = int ( \frac{{b}_{i}}{2} ) + \{ \begin{matrix}append 0 & if {b}_{i - 1} is E \\ append 5 & else\end{matrix}$ | $Sum = \{ \begin{matrix}0 & if c is E \\ 5 & else\end{matrix}$ |

### RealFlow Multiplier—9 Method

In Table 37, the context of the base-10 positional number system, RFM-9 method elucidates that when a single-digit integer a is multiplied by 9, the resultant product takes on a specific form: 9 times a=(a−1): (10−a), valid for values of a ranging from 1 to 9. To comprehend this, one must start by expressing 9 as a difference between 10 and 1. When this is multiplied by a, and the product is expanded by distributing ‘a’ across these terms, we get an expression of (10a−a). Intriguingly, this expression can be interpreted in terms of our positional system: the term 10a essentially shifts the digit ‘a’ to the tens place. When this is juxtaposed with the subtracted ‘a’, the decomposition clearly reveals the digits of the resulting product. The term representing the tens place is (a−1), while the unit's place has the digit (10-a). Thus, whenever a single-digit integer is multiplied by 9, the product invariably manifests as a two-digit number, with the tens digit being (a−1) and the units digit as (10-a).

TABLE 37

| | |
|---|---|
| Statement of the Problem: | 9 × a = 10(a − 1) + (10 − a) |
| Proof for: | a one-digit integer a |
| Representation of 9: | 9 = 10 − 1 |
| Distributive Property: | 9 × a = (10 − 1) × a = |
| | 10a − a = |
| | 10a − 10 + 10 − a |
| Substitution: | =10(a − 1) + (10 − a) |
| or | =(a − 1):(10 − a) |

When executing a convolution operation with the sequence (a: bᵢ: c) and 9, the process reveals a distinctive pattern. Beginning from the least significant digit of a: bᵢ: c, the initial overlap equates to a−1, which subsequently corresponds to (a−1) multiplied by 10^{m+1}. The following overlap produces (bᵢ+9−bᵢ₋₁)), taking the form (bᵢ+9−bᵢ₋₁) multiplied by 10^{m}. Advancing further, upon reaching the overlap at position m+1, the term emerges as bₘ+9−bₘ₋₁ and is multiplied by 10. Lastly, the overlap at

TABLE 38

| Number of | | | | | |
|---|---|---|---|---|---|
| steps | 1 | 2 | ----------------- | m + 1 | m + 2 |
| ${\begin{matrix}c & {b}_{i} & a\end{matrix}}^{⟶}$ | (dv − 1) | (10 − dv) | | | |
| | a − 1 | 10 − bᵢ₋₁ | | | |
| | | bᵢ − 1 | | | |
| | | | ----------------- | [symbol] | |
| | | | | 10 − bₘ₋₁ | |
| | | | | bₘ − 1 | |
| Sum (0 ≤ | a − 1 | (bᵢ − 1) + | | (bₘ − 1) + | 10 − C |
| I ≤ m) | | (10 − bᵢ₋₁) | | (10 − bₘ₋₁) | |
| | a − 1 | (bᵢ + 9 − bᵢ₋₁) | | bₘ + 9 − bₘ₋₁ | 10 − C |

$= a - 1 : {b}_{i} + 9 - {b}_{i - 1} : 10 - c = {10}^{m + 1} ( a - 1 ) + {\sum }_{i = 0}^{{i}_{m}} 1 {0}^{m - i} [ {b}_{i} + 9 - {b}_{i - 1} ] + ( 10 - c )$

position m+2 simply results in (10−c). Synthesizing these results, the entire convolution is expressed as 9 a: bi: c, which can be simplified to (a−1): bᵢ+(9−bᵢ₋₁):(10−c). Here, it's critical to consider b−1=a, bm=c for accuracy. The intricate overlap operation between 9 and a: bᵢ: c can be represented in TABLE 38, which encapsulates this convolution process comprehensively.

TABLE 39 contemplating the multiplication of 9 by 98774321, reveals an intriguing pattern illuminated through a defined set of arithmetic rules applied systematically to each digit. The first digit, 9, is processed with a straightforward subtraction, (9−1), producing an 8. For the following middle digits, a prescribed rule of bᵢ+(9−bᵢ₋₁) is employed. For instance, with digits 9 and 8, we observe (9−9+8), yielding 8. Similarly, the digits 8 and 7 provide (9−8+7), which also gives 8, and this computation sequence continues through all the middle digits, exposing a rhythmic pattern in the results: 88896888. Lastly, for the final digit, 1, a simple rule of (10−c) is utilized, giving us a 9. Thus, the resulting product becomes 888968889.

TABLE 39

| | | | | | | | | | |
|---|---|---|---|---|---|---|---|---|---|
| 9 | x | 9 | 8 | 7 | 7 | 4 | 3 | 2 | 1 |

| | | | | | | | | | |
|---|---|---|---|---|---|---|---|---|---|
| rule | 9 − 1 = | 9 − 9 + | 9 − 8 + | 9 − 7 + | 9 − 7 + | 9 − 4 + | 9 − 3 + | 9 − 2 + | 10 − 1 = |
| | 8 | 8 = 8 | 7 = 8 | 7 = 9 | 4 = 6 | 3 = 8 | 2 = 8 | 1 = 8 | 9 |
| result | 8 | 8 | 8 | 9 | 6 | 8 | 8 | 8 | 9 |

TABLE 40 unfolds the multiplication of 9 by 71365743, in which the pivotal role is played by the adept management of the carry-over mechanism. The initial digit, 7, following the rule (a−1), translates to 6. As we traverse through the middle digits, denoted as (bᵢ), the rule bᵢ+(9−bᵢ₋₁) is engaged. To illustrate, applying this rule to digits 7 and 1: (9−7+1) equals 3. Moving to digits 1 and 3, (9−1+3) results in 11. We retroactively add a carry-over of 1 to the previous result, adjusting the 3 to 4. Sequentially, addressing digits 3 and 6, the operation (9−3+6) equals 12, reintroducing a retroactive carry-over and modifying the former 1 to 2. Such a methodology, perpetuating the application of carry-overs to refine prior calculations, continues throughout the operation. The final digit, 3, is managed by the rule (10−c), where (10−3) generates 7, the accurate product of the multiplication, 6422291687.

TABLE 40

| | | | | | | | | | |
|---|---|---|---|---|---|---|---|---|---|
| 9 | x | 7 | 1 | 3 | 6 | 5 | 7 | 4 | 3 |

| | | | | | | | | | |
|---|---|---|---|---|---|---|---|---|---|
| Mid-result | 7 − 1 = | 9 − 7 + | 9 − 1 + | 9 − 3 + | 9 − 6 + | 9 − 5 + | 9 − 7 + | 9 − 4 + | 10 − 3 = |
| | 6 | 1 = 3 | 3 = 11 | 6 = 12 | 5 = 8 | 7 = 11 | 4 = 6 | 3 = 8 | 7 |
| Final result | 6 | 4 | 2 | 2 | 9 | 1 | 6 | 8 | 7 |

### The RealFlow Multiplier Algorithm-9

For RFMA-9, TABLE 41 provides specific computational formulas: In box 202, the value Re is represented as R₉=(a−1). In box 206, the sum is calculated by adding the nines' complement of the previous digit to the current digit. Meanwhile, in box 214, the sum is the tens' complement of ‘c’. All these computations are inputted in FIG. 2.

TABLE 41

Box number

| | In 202 | In 206 | In 214 |
|---|---|---|---|
| Rule | R9 = (a − 1) | Sum = bᵢ + (9 − bᵢ₋₁) | Sum = (10 − c) |

### The RealFlow Multiplier Method-4

TABLE 42 meticulously elucidates the RealFlow Multiplier Method-4a (RFMM-4a), shedding light on the intricacies involved when tailoring the single-digit multiplicand, 4. The aim is to transpose it into a two-digit form, making it apt for application within the RFMA-4a framework. By deconstructing the multiplication process using both even and odd numbers, the table offers comprehensive proof of this transformation.

TABLE 42

| Statement of the Problem: | $4 \times a = int ( \frac{a}{2} ) - 1 : \{ \begin{matrix}10 - a if a E \\ 10 - a + 5 if a is an O\end{matrix}$ | |
|---|---|---|
| Proof for: | Even a | Odd a |
| Representation | 4 = 5 − 1 | 4 = 5 − 1 |
| of 4: | | |
| Distributive | 4 × a = (5 − 1) × a | 4 × a = (5 − 1) × a |
| Property: | = 5a − a | = 5a − a |
| | = 5a − 10 + | = 5a − 5 − 10 + 10 − |
| | 10 − a | a + 5 |
| Substitution: | = 10[(a/2) − 1] + | = [10((a − 1)/2) − 1] + 10 − |
| | 10 − a | a + 5 |

| | |
|---|---|
| Combination: | $= int ( \frac{a}{2} ) - 1 : \{ \begin{matrix}10 - a if a E \\ 10 - a + 5 if a is an O\end{matrix}$ |

TABLE43 meticulously explores the RealFlow Multiplier Method-4b (RFMM-4b), highlighting its sophisticated approach to managing two-digit multiplicands as an alternative to the singular value of 4. Delving into the calculations, the table distinctly showcases that when multiplying any integer, the formula is derived as int(a/2):int(bi/2) coupled with certain condition-based adjustments. Specifically, when the preceding digit is even, a subtraction of that digit from 10 is required. However, when dealing with an odd precedent, an additional 5 is appended to the equation, emphasizing the method's inherent nuances. This systematized presentation stands as robust evidence of the RFMM-4b's capability to adeptly handle two-digits multiplicands, showcasing its precision and adaptability in capturing the subtleties of integer multiplication.

TABLE 44 utilizes a mathematical strategy for multiplying the number 824742 by 4, a series of calculated steps are undertaken to seamlessly determine each digit of the resulting product, without the complexity of handling carry-overs. Commencing with the leftmost digit, 8, it is halved and reduced by 1, subsequently producing the first digit, 3, of the resultant number. Progressing to the adjacent digits, 8 and 2, the formula (9−8)+int (2/2) is applied, unveiling 2 as the succeeding digit. Navigating through the

TABLE 43

| Number of | | | | | |
|---|---|---|---|---|---|
| steps | 1 | 2 | ---- | m + 1 | m + 2 |
| ${\begin{matrix}c & {b}_{i} & a\end{matrix}}^{⟶}$ | $int ( \frac{dv}{2} ) - 1$ | $\{ \begin{matrix}10 - dv if {b}_{i} is E \\ 10 - dv + 5 else\end{matrix}$ | | | |
| | $int ( \frac{a}{2} ) - 1$ | $\{ \begin{matrix}10 - {b}_{i - 1} if {b}_{i - 1} is E \\ 10 - {b}_{i - 1} + 5 else\end{matrix}$ | | | |
| | | $int ( \frac{{b}_{i}}{2} ) - 1$ | | | |
| | | | -- | [symbol] | |
| | | | | $\{ \begin{matrix}10 - {b}_{m - 1} if {b}_{m - 1} is E \\ 10 - {b}_{m - 1} + 5 else\end{matrix}$ | |
| | | | | $int ( \frac{{b}_{m}}{2} ) - 1$ | |
| Sum (0 ≤ I ≤ m) | $int ( \frac{a}{2} ) - 1$ | $int ( \frac{{b}_{i}}{2} ) + \{ \begin{matrix}9 - {b}_{i - 1} if {b}_{i - 1} is E \\ 9 - {b}_{i - 1} + 5 else\end{matrix}$ | | $int ( \frac{{b}_{m}}{2} ) + \{ \begin{matrix}9 - {b}_{m - 1} if {b}_{i - 1} is E \\ 9 - {b}_{m - 1} + 5 else\end{matrix}$ | $\{ \begin{matrix}10 - c if c is E \\ 10 - c + 5 else\end{matrix}$ |

$4 \times ( a : {b}_{i} : c ) = int ( \frac{a}{2} ) - 1 : int ( \frac{{b}_{i}}{2} ) + \{ \begin{matrix}9 - {b}_{i - 1} if {b}_{i - 1} is E \\ 9 - {b}_{i - 1} + 5 else\end{matrix} : \{ \begin{matrix}10 - c if c is E \\ 10 - c + 5 else\end{matrix}$

number, utilizing the digits 2 and 4, and then 4 and 7, the digits 9 and 8 are successively derived, respectively, by executing the same systematic procedure. As the methodology persistently advances, relying on the digits 7 and 4, and 4 and 2, the subsequent digits of 9 and 6 are extracted. Conclusively, the process terminates by subtracting the rightmost digit, 2, from 10, obtaining an 8 and finalizing the product as 3,298,968. This systematic approach facilitates multiplication by 4, adeptly determining each individual digit of the product in a sequential and comprehensible manner.

TABLE 44

| | | | | | | | |
|---|---|---|---|---|---|---|---|
| 4 | × | 8 | 2 | 4 | 7 | 4 | 2 |

| | | | | | | | |
|---|---|---|---|---|---|---|---|
| rule | $\frac{8}{2} - 1 =$ | $( 9 - 8 + \frac{2}{2} ) = 2$ | $( 9 - 2 + \frac{4}{2} ) = 9$ | $( 9 - 4 + \frac{7}{2} ) = 8$ | $5 + ( 9 - 7 + \frac{4}{2} ) = 9$ | $( 9 - 4 + \frac{2}{2} ) = 6$ | (10 − 2) = 8 |
| result | 3 | 2 | 9 | 8 | 9 | 6 | 8 |

TABLE 45 engages with the number 628357 and multiplying it by 4, the method involves a series of arithmetic manipulations through the pre-established rule set. Starting with the first digit 6, (int (6/2)−1) is calculated to yield the first digit of our product, 2. Transitioning to the second digit, considering 6 and 2, the rule suggests that we compute (9−6)+int (2/2)=4, hence arriving at the next digit. Moving forward to digits 2 and 8, a calculation of 9−2+int (8/2) generates a sum of (11). Here, a crucial aspect emerges; the tens digit (1) is carried over to the previously calculated result, amending it from 4 to 5, while the unit digit (1) holds its position in the product. Continuing the progression with the digits 8 and 3, (9−8)+int (3/2) provides us with 2. Transitioning to digits 3 and 5, the expression 5+(9−3)+int (5/2) yields a total of 13. Carry over the 1 to the previous result and append 3 to it. Shifting to digits 5 and 7, the calculation 5+(9-5)+int (7/2) results in a sum of 12. Carry over the 1 to the previous result and concatenate 2 to it. For the last digit 7, since it's odd, add 5 to (10−7) to get 8, and append it.

TABLE 45

| | | | | | | | |
|---|---|---|---|---|---|---|---|
| 4 | × | 6 | 2 | 8 | 3 | 5 | 7 |

| | | | | | | | |
|---|---|---|---|---|---|---|---|
| rule | $\frac{6}{2} - 1 = 2$ | $( 9 - 6 + \frac{2}{2} ) = 4$ | $( 9 - 2 + \frac{8}{2} ) = 11$ | $( 9 - 8 + \frac{3}{2} ) = 2$ | $5 + ( 9 - 3 + \frac{5}{2} ) = 13$ | $5 + ( 9 - 5 + \frac{6}{2} ) = 12$ | 5 + (10 − 7) = 8 |
| result | 2 | 5 | 1 | 3 | 4 | 2 | 8 |

### RealFlow Multiplier Algorithm-4

TABLE 46 details specific computational guidelines. In box 202, the value designated as “R₄” is calculated as R₄=(a−1). In the subsequent procedure at box 206, the sum is determined by adding the nines' complement of the preceding digit to the half of the current digit, if the previous digit is even. However, if it's odd, an additional 5 is added to the sum. Meanwhile, in box 214, the sum is deduced to be the tens complement of c. For even c values, the sum remains as the tens complement, but for odd c values, an additional 5 is added. All these arithmetic processes are visually represented in RFMA-4.

TABLE 46

| Box | | | |
|---|---|---|---|
| number | In 202 | In 206 | In 214 |
| Rule | $R 6 = int ( \frac{a}{2} )$ | $Sum = in ( \frac{{b}_{i}}{2} ) + \{ \begin{matrix}9 - {b}_{i - 1} if {b}_{i - 1} is E \\ 9 - {b}_{i - 1} + 5 else\end{matrix}$ | $Sum = \{ \begin{matrix}( 10 - c ) if c is E \\ ( 10 - c ) + 5 else\end{matrix}$ |

### The RealFlow Multiplier Method-8

TABLE 47 precisely showcases the Base-10 Decomposition methodology when a single-digit integer (a) is multiplied by 8. By this method, the product manifests as a two-digit number where (a−2) occupies the tens position and (2(10−a)) the unit's position. This depiction aligns perfectly with understanding multiplication in a base-10 context, deviating from the standard multiplication norms. The table not only serves as an illuminating guide but also stands as a compelling testament to the accuracy and flexibility of the Base-10 Decomposition method in this particular setting. In essence, TABLE 47 demonstrates and validates the potency of this innovative approach, reinforcing its utility in mathematical computation.

TABLE 47

| | |
|---|---|
| Statement of the Problem: | 8 × a = 10(a − 2) + 2(10 − a) |
| Proof for: | a one-digit integer a |
| Representation of 8: | 8 = 10 − 2 |
| Distributive Property: | 8 × a = (10 − 2) × a = |
| | 10a − 2a = |
| | 10a − 20 + 20 − 2a |
| Substitution: | =10(a − 2) + 2(10 − a) |
| or | =(a − 2):2(10 − a) |

When conducting a convolution operation with the sequence (a: bᵢ: c) and 8, a unique pattern surface. Commencing from the least significant digit of (a: bac), the initial overlap amounts to (a−2), which then corresponds to (a−2) times 10^{m+1}. The ensuing overlap yields bᵢ+2(9−bᵢ₋₁), adopting the form bᵢ+2(9−bᵢ₋₁) times 10^{m}. Proceeding onward, once the overlap at position (m+1) is reached, the term manifests as bₘ+2(9−bₘ₋₁) and is multiplied by 10. Finally, the overlap at position (m+2) directly results in 2(10−c). Compiling these findings, the entire convolution is

TABLE 48

| Number of | | | | | |
|---|---|---|---|---|---|
| steps | 1 | 2 | ----------------- | m + 1 | m + 2 |
| ${\begin{matrix}c & {b}_{i} & a\end{matrix}}^{⟶}$ | (dv − 2) | 2(10 − dv) | | | |
| | a − 2 | 2(10 − bᵢ₋₁) | | | |
| | | bᵢ − 2 | | | |
| | | | ----------------- | [symbol] | |
| | | | | 2(10 − bₘ₋₁) | |
| | | | | bₘ − 2 | |
| Sum (0 ≤ | a − 2 | (bᵢ₋ − 2) + | | (bₘ − 2) + | 2(10 − C) |
| i ≤ m) | | 2(10 − bᵢ₋₁) | | 2(10 − bₘ₋₁) | |
| | a − 2 | (bᵢ + 2(9 − bᵢ₋₁)) | | bₘ + 2(9 − bₘ₋₁) | 2(10 − C) |

$= a - 2 : {b}_{i} + 2 ( 9 - {b}_{i - 1} ) : 2 ( 10 - c ) = {10}^{m + 1} ( a - 2 ) + {\sum }_{i = 0}^{{i}_{m}} 1 {0}^{m - i} [ {b}_{i} + 2 ( 9 - {b}_{i - 1} ) ] + 2 ( 10 - c )$

expressed as 8 times (a: bᵢ: c), which can be distilled to (a−2): bᵢ+2(9−bᵢ₋₁): 2(10−c). In this context, it's pivotal to affirm (b₋₁=a, bₘ=c to maintain accuracy. The complex overlap operation between 8 and (a: bᵢ: c) can be portrayed in TABLE 48, which thoroughly encapsulates this convolution process.

In TABLE 49, where we examine the multiplication of 8 by 999987, an attentive application of a specified rule and strategic management of the calculations are crucial. To begin, the first digit, 9, transforms to 7 by applying the rule (a−2). Moving to the middle digits, denoted by bᵢ, the rule bᵢ+2(9−bᵢ₋₁) is employed. For instance, we compute (2(9−9)+9), which yields 9. This same operation is performed for the next set of 9's, repeatedly providing a result of 9. When we reach the digits 9 and 8, the operation becomes (2(9−9)+8), resulting in 8. For the digits 8 and 7, the computation turns into 2(9−8)+7), which also produces 9. The final digit, 7, is manipulated by rule 2(10−c), where 2(10−7) equals 6. The accurate product of the multiplication emerges as 7999896.

TABLE 49

| | | | | | | | |
|---|---|---|---|---|---|---|---|
| 8 | x | 9 | 9 | 9 | 9 | 8 | 7 |

| | | | | | | | |
|---|---|---|---|---|---|---|---|
| Mid-result | 9 − 2 = | 2(9 − 9) + | 2(9 − 9) + | 2(9 − 9) + | 2(9 − 9) + | 2(9 − 8) + | 2(10 − 7) = |
| | 7 | 9 = 9 | 9 = 9 | 9 = 9 | 8 = 8 | 7 = 8 | 6 |
| Final- | 7 | 9 | 9 | 9 | 8 | 9 | 6 |
| result | | | | | | | |

In TABLE 50, we engage with the multiplication of 8 by 713,657, utilizing a particular rule set and an attentive management of calculations. Beginning with the digit 7, the rule (a−2) translates it to 5. Progressing to the middle digits, labeled as bᵢ, we use the rule bᵢ+2(9−bᵢ₋₁). For instance, for the digits 7 and 1, the operation (2(9−7)+1) results in 5. Proceeding to the digits 1 and 3, the operation (2(9−1)+3) yields 19. The response here is to register the unit digit (9) and carry-over the tenth digit (1) to refine the previous result, adjusting the preceding 5 to 6. Then, for the digits 3 and 6, the operation (2(9−3)+6) delivers 18, inciting a similar action: keeping the 8 and enhancing the former 9 to 10, which becomes a 0 with a carry-over of 1. Further, for the digits 6 and 5, the operation (2(9−6)+5) gives 11, registering 1 and converting the prior 8 to 9. For digits 5 and 7, the operation (2(9−5)+7) delivers 15, prompting a carry-over of 1 to be added to the result of the preceding pair of digits, transforming the 2 to 3. The last digit, 7, is tackled by the rule (2(10−c)), in which (2(10−7) equals 6. The end product of the multiplication is 5709256.

TABLE 50

| | | | | | | | |
|---|---|---|---|---|---|---|---|
| 8 | x | 7 | 1 | 3 | 6 | 5 | 7 |

| | | | | | | | |
|---|---|---|---|---|---|---|---|
| Mid-result | 7 − 2 = 5 | 2(9 − 7) + | 2(9 − 1) + | 2(9 − 3) + | 2(9 − 6) + | 2(9 − 5) + | 2(10 − 7) |
| | | 1 = 5 | 3 = 19 | 6 = 18 | 5 = 11 | 7 = 15 | 6 |
| Final- | 5 | 7 | 0 | 9 | 2 | 5 | 6 |
| result | | | | | | | |

### The RealFlow Multiplier Algorithm-8

For RFMA-8, TABLE 51 presents specific computational outcomes: In box 202, the value R₈ is derived from R₈=(a−2). In box 206, the sum is the result of adding the current digit bᵢ to twice the nines complement of the previous digit (bᵢ₋₁). Meanwhile, in box 214, the sum is twice the tens complement of ‘c’. Certainly. Here's a revised version:

TABLE 51

| In 202 | In 206 | In 214 |
|---|---|---|
| Ra = (a − 2) | Sum = bᵢ + 2(9 − bᵢ₋₁) | Sum = 2(10 − c) |

### The RealFlow Multiplier Method-3

TABLE 52 meticulously showcases the steps involved when multiplying a single-digit integer (a) by 3, using a base-10 decomposition approach. For cases where (a) is even, the multiplication is streamlined as (3×a=10(a/2)−2+2(10−a)) or can be written 3×a=[(a/2)−2]: [2(10−a)]. When (a) is odd, the procedure becomes (3×a=10[(a−1)/2]−2+2(10−a)+5). This table succinctly presents the steps for both scenarios, acting as definitive proof of the method's accuracy for each case, thereby emphasizing the adaptability and precision of the base-10 decomposition technique in handling such calculations.

TABLE 52

| Statement of the Problem: | $3 \times a = int ( \frac{a}{2} ) - 2 : \{ \begin{matrix}2 ( 10 - a ) if a is E \\ 2 ( 10 - a ) + 5 if a is O\end{matrix}$ | |
|---|---|---|
| Proof for: | Even a | Odd a |
| Representation | 3 = 5 − 2 | 3 = 5 − 2 |
| of 3: | | |
| Distributive | 3 × a = (5 − 2) × a | 3 × a = (5 − 2) × a |
| Property: | = 5a − 2a | = 5a − 2a |
| | = 5a − 20 + 20 − | = 5a − 5 − 20 + 20 − |
| | 2a | 2a + 5 |
| Substitution: | = 10[(a/2) − 2] + 2(10 − | = 10[((a − 1)/2) − 2] + |
| | a) | 2(10 − 2a) + 5 |

| | |
|---|---|
| Combination: | $= \{ \begin{matrix}10 [ ( a / 2 ) - 2 ] + 2 ( 10 - a ) if a is E \\ [ 10 ( ( a - 1 ) / 2 ) - 1 ] + 2 ( 10 - a ) + 5 if a is an O\end{matrix}$ |
| or | $= int ( \frac{a}{2} ) - 2 : \{ \begin{matrix}2 ( 10 - a ) if a is E \\ 2 ( 10 - a ) + 5 if a is O\end{matrix}$ |

TABLE 53 shows the proof for convolution the sequence (a: bᵢ: c) and 3, a unique pattern surface. Commencing from the least significant digit of (a: bᵢ: c), the initial overlap amounts to int (a/2)−2), which then corresponds to int (a/2)−2) times 10^{m+1}. The ensuing overlap yields

$$int ( \frac{{b}_{i}}{2} ) + 2 ( 9 - {b}_{i - 1} )$$

for even bᵢ₋₁ otherwise 5 has to be added, adopting the form

$$int ( \frac{{b}_{i}}{2} ) + 2 ( 9 - {b}_{i - 1} )$$

times 10^{m}. Proceeding onward, once the overlap at position (m+1) is reached, the term manifests as int

$$( \frac{{b}_{m}}{2} ) + 2 ( 9 - {b}_{m - 1} ) ,$$

with adding 5 when bₘ₋₁ is odd and is multiplied by 10. Finally, the overlap at position (m+2) directly results in 2(10−c) when c is even otherwise 5 is added.

TABLE 54, labeled RFM-3 method Example 1, offers a lucid walkthrough of multiplying the number 999986 by 3, employing a unique and specific rule set tailored for this mathematical endeavor. The initial digit, 9, is subjected to the rule of

TABLE 53

| Number of | | | | | |
|---|---|---|---|---|---|
| steps | 1 | 2 | --- | m + 1 | m + 2 |
| ${\begin{matrix}c & {b}_{i} & a\end{matrix}}^{⟶}$ | $int ( \frac{dv}{2} ) - 2$ | $\{ \begin{matrix}2 ( 10 - dv ) if dv is E \\ 2 ( 10 - dv ) + 5 else\end{matrix}$ | | | |
| | $int ( \frac{a}{2} ) - 2$ | $\{ \begin{matrix}2 ( 10 - {b}_{i - 1} ) if {b}_{i - 1} \text{?} \\ 2 ( 10 - {b}_{i - 1} ) + 5 else\end{matrix}$ | | | |
| | | $int ( \frac{{b}_{i}}{2} ) - 2$ | | | |
| | | | ---- | [symbol] | |
| | | | | $\{ \begin{matrix}2 ( 10 - {b}_{m - 1} ) if {b}_{m - 1} \text{?} \\ 2 ( 10 - {b}_{m - 1} ) + 5 \text{?}\end{matrix}$ | |
| | | | | $int ( \frac{{b}_{m}}{2} ) - 2$ | |
| Sum (0 ≤ i ≤ m) | $int ( \frac{a}{2} )$ | $int ( \frac{{b}_{i}}{2} ) + \{ \begin{matrix}2 ( 9 - {b}_{i - 1} ) if {b}_{i - 1} \text{?} \\ 2 ( 10 - {b}_{i - 1} ) + 5 \text{?}\end{matrix}$ | | $int ( \frac{{b}_{m}}{2} ) + \{ \begin{matrix}2 ( 9 - {b}_{m - 1} ) if {b}_{i - 1} \text{?} \\ 2 ( 9 - {b}_{m - 1} ) + 5 \text{?}\end{matrix}$ | $\{ \begin{matrix}2 ( 10 - c ) if c \text{?} \\ 2 ( 10 - c ) + 5 \text{?}\end{matrix}$ |

$= int ( \frac{a}{2} ) : int ( \frac{{b}_{i}}{2} ) + \{ \begin{matrix}2 ( 9 - {b}_{i - 1} ) if {b}_{i - 1} is E \\ 2 ( 9 - {b}_{i - 1} ) + 5 else\end{matrix} : \{ \begin{matrix}2 ( 10 - c ) if c is E \\ 2 ( 10 - c ) + 5 else\end{matrix}$
$\text{?} \text{indicates text missing or illegible when filed}$

int(a/2)−2, which upon calculation provides the number 2 as the first digit of our resultant product. The middle digits, denoted as (bᵢ), navigate through a slightly more nuanced path, with the rule diverging based on the evenness or oddness of the preceding digit, bᵢ₋₁. If bᵢ₋₁ is even, we utilize the formula

$$int ( \frac{{b}_{i}}{2} ) + \{ \begin{matrix}2 ( 9 - {b}_{i - 1} ) if {b}_{i - 1} is E \\ 2 ( 9 - {b}_{i - 1} ) + 5 else\end{matrix} .$$

Proceeding with these rules for the digits in 999986, we meticulously compute: for 99, it's (5+2(9−9)+int(9/2) equating to 9; for 98, it alters slightly to (5+2 (9−9)+int(8/2), still equating to 9; and for 86, switching to the even rule, it's (2(9-8)+int(6/2) giving us 5. For the final digit, 6, we employ a different rule: if it's even, we apply (2(10−c)), and if it's odd, we tweak it to (2(10−c)+5). Thus, for our digit 6, which is even, the formula

TABLE 54

| | | | | | | | |
|---|---|---|---|---|---|---|---|
| 3 | * | 9 | 9 | 9 | 9 | 8 | 6 |

| | | | | | | | |
|---|---|---|---|---|---|---|---|
| rule | $\frac{9}{2} - 2 =$ | $5 + 2 ( 9 - 9 ) + \frac{9}{2} = 9$ | $5 + 2 ( 9 - 9 ) + \frac{9}{2} = 9$ | $5 + 2 ( 9 - 9 ) + \frac{9}{2} = 9$ | $5 + 2 ( 9 - 9 ) + \frac{8}{2} = 9$ | $2 ( 9 - 8 ) + \frac{6}{2} = 5$ | 2(10 − 6) = 8 |
| result | 2 | 9 | 9 | 8 | 9 | 5 | 8 |

(2(10−6)) provides us with 8 as the final digit in our sequence. Navigating through these calculated steps, our result emanates as the number 2998958.

TABLE 55 details another multiplication example of the number 739186 by 3 using a RFM-3 rules and managing carry-over between computational steps. The initial rule for the first digit, 7, is (int (7/2)−2), yielding a starting result of 1. Moving to the pair 7 and 3, applying (5+2(9−7)+int(3/2)) delivers a total of 10. Here, we carry over the 1 to our initial digit, converting it into a 2, and noting down a 0 for our current position evolving result: 20. For the next pair, 3 and 9, the calculation produces 21; now we transfer the tens place 2 to the previous 0, converting it into a 2, while the 1 takes its position, and our answer morphs into 221. Continually applying this mechanism for all middle digits. For the final digit 6, which is even, the formula (2(10−6) provides us 8 as the final digit in our sequence. Navigating through these calculated steps, our result emanates as number 2217558.

TABLE 55

| | | | | | | | |
|---|---|---|---|---|---|---|---|
| 3 | * | 7 | 3 | 9 | 1 | 8 | 6 |

| | | | | | | | |
|---|---|---|---|---|---|---|---|
| rule | $\frac{7}{2} - 2 =$ | $5 + 2 ( 9 - 7 ) + \frac{3}{2} = 10$ | $5 + 2 ( 9 - 3 ) + \frac{9}{2} = 21$ | $5 + 2 ( 9 - 9 ) + \frac{1}{2} = 5$ | $5 + 2 ( 9 - 1 ) + \frac{8}{2} = 25$ | $2 ( 9 - 8 ) + \frac{6}{2} = 5$ | 2(10 − 6) = 8 |
| result | 2 | 2 | 1 | 7 | 5 | 5 | 8 |

### RealFlow Multiplier Algorithm-3

TABLE 56 presents a series of computational directives. In box 202, the value designated “R3” is derived from the integer division of a by 2, expressed as R3=int (a/2). Moving on to box 206, the sum is found by adding half of the current digit to twice the nines' complement of the previous digit, if the previous digit (bᵢ₋₁) is even. In contrast, if (bᵢ₋₁) is odd, an additional 5 is added to the sum. Finally, in box 214, the sum is derived from twice the tens' complement of ‘c’. If ‘c’ is even, However, if ‘c’ is odd, an additional 5 is added to twice the tens' complement. These mathematical operations are depicted in RFMA-3.

TABLE 56

| Box | | | |
|---|---|---|---|
| number | In 202 | In 206 | In 214 |
| Rule | $R 6 = int ( \frac{a}{2} )$ | $Sum = in ( \frac{{b}_{i}}{2} ) + \{ \begin{matrix}9 - {b}_{i - 1} if {b}_{i - 1} is E \\ 9 - {b}_{i - 1} + 5 else\end{matrix}$ | $Sum = \{ \begin{matrix}( 10 - c ) if c is E \\ ( 10 - c ) + 5 else\end{matrix}$ |

### RealFlow Multiplier Algorithm-2

TABLE 57 comprehensively details the guidelines inherent to RFMA-2. In box 202, “R₂” is distinctly defined as ‘a’, specifically equaling twice the value of ‘a’. Transitioning to box 206, the sum rule incorporates the current digit (b₀) and results in a value that is precisely double that of (b₀). Conversely, within box 214, the sum is intentionally omitted, choosing instead to manage the variables contained within, as graphically depicted in FIG. 2.

TABLE 57

Box number

| | 202 | 206 | 214 |
|---|---|---|---|
| Rule | R2 = 2a | Sum = 2a | Skip the sum |

### RealFlow Multiplier Algorithm-1

TABLE 58 methodically presents the protocols inherent to the three segments of RFMA-1. Within box 202, the value R1 is initialized as ‘a’. For box 206, the result is derived from the equation sum=current digit (bᵢ). Conversely, in box 214, rather than performing the sum, other predefined operations are executed, all of which is graphically detailed in FIG. 3.

TABLE 58

Box number

| | 202 | 206 | 214 |
|---|---|---|---|
| Rule | R1 = a | Sum = bᵢ | Skip the sum |

### RealFlow Multiplier Algorithm-0

TABLE 59 thoroughly delineates the protocols pertaining to the discrete sections of RFMA-0. Within box 202, the rule R0 is assigned the value ‘0’. In box 206 adheres sum=0. Box 214, meanwhile, diverts from summation activities, instead opting to produce zeros depending on multiplier digits number. In box 214 skip the sum and handle the variables in it as illustrated in FIG. 3.

TABLE 59

Box number

| | 202 | 206 | 214 |
|---|---|---|---|
| Rule | R0 = 0 | Sum = 0 | Skip the sum |

### Complex Numbers

### Method for Multiplying Complex Numbers in Decimal Form

The present invention relates to a method for efficiently multiplying complex numbers represented in decimal form. Given two complex numbers, a+bᵢ and c+dᵢ, where a and c are the real components and b and d are the imaginary components, the method encompasses: multiplying the real components a and c to derive ac; multiplying the real component a of the first number by the imaginary component d of the second to obtain ad; multiplying the imaginary component b of the first number by the real component c of the second, resulting in bc; and multiplying the imaginary components b and d, with the consideration that i2=−1, yielding −bd. The final product is the summation of these individual products, represented as ac−bd for the real part and ad+bc for the imaginary part. The invention provides a systematic and clear approach to complex number multiplication, addressing the need for precision and clarity in mathematical operations across various fields.

The RFMA (Real Flow Multiplier Algorithm) is a highly efficient method that can significantly benefit matrix multiplications. It excels in real-time computations and operates in a parallel fashion, which makes it particularly well-suited for complex matrix operations. What sets RFMA apart is its ability to avoid redundant digit calculations. Instead of recomputing digits, it intelligently copies and places them in their appropriate positions by referencing stored values. This unique approach not only speeds up the multiplication process but also conserves computational resources, making it an invaluable tool for optimizing matrix multiplication workflows. Furthermore, RFMA offers the added advantage of performing multiplication in the decimal system without the need for conversion to binary. This feature simplifies the computation process and reduces the potential for errors that can arise during conversion, making RFMA a versatile and time-saving choice for a wide range of numerical calculations, including matrix multiplications.

### Decimal Convolution Algorithm

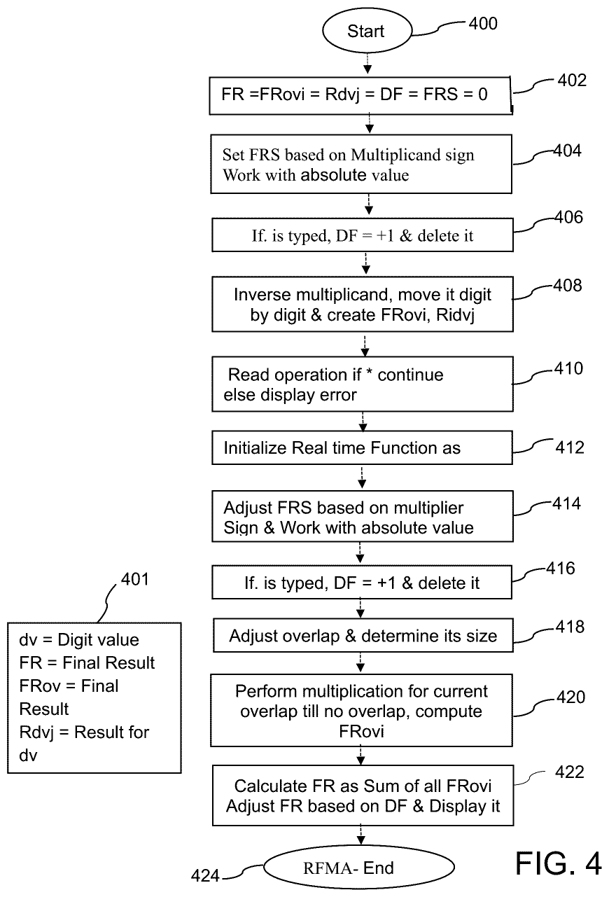

FIG. 4 illustrates the flowchart of decimal convolution. The depicted flowchart systematically outlines the sequential steps involved in executing the Decimal Convolution Multiplier Algorithm (DCMA) with step 400 marking the start of DCMA and laying the foundation for the algorithm's operation. Following this, step 402 initializes several variables, such as FR=FRₒᵥᵢ=R_{dvj}=DF=FRS=0, setting them to zero to ensure a clean slate for the computations ahead.

Subsequently, step 404 sets FRS based on the multiplicand sign, working with the absolute value. The algorithm then proceeds to step 406, where it checks for a decimal point. If encountered, DF is set to +1, and the decimal point is deleted. In step 408, the Inverse multiplicand is moved digit by digit to create FRₒᵥᵢ and R_{dvj}. Ensuring accuracy in the operation, step 410 reads the operation. If multiplication is detected, the process continues; otherwise, an error is displayed, indicating an incorrect operation. Step 412 is crucial for initializing the Real-time Function as Curses, allowing for real-time adjustments and computations. Step 414 plays a pivotal role in adjusting the Final Result Sign (FRS) based on the multiplier sign; if the signs are similar, it remains unchanged; otherwise, it is altered. This step ensures the correct sign of the final result, considering both the multiplicand and the multiplier's signs.

Another check for a decimal point occurs at step 416, with similar actions as before. When a decimal point is identified, it triggers an increment of the Decimal Fraction (DF) by +1 and eliminates the decimal point, considering there is no decimal fraction left. Following this, step 418 adjusts overlap and determines its size.

Delving into the DCMA overlaps in step 420, the algorithm performs multiplication for the current overlap until there is no overlap, computing FRₒᵥᵢ.

The penultimate step, 422, calculates FR as the sum of all FRₒᵥᵢ and adjusts FR based on DF, displaying it. Lastly, step 424 marks the end of RFMA-11, signifying the completion of the Real Flow Multiplier Algorithm. This comprehensive flowchart, complemented by the definitions provided in step 401, offers a structured and detailed overview of the CDMA, enhancing understanding and implementation of this algorithm.

What is claimed is:

1. A multiplication algorithm method termed as the Real Flow Multiplier Algorithm (RFMA), comprising:
The algorithm is based on two principles: first, convolution multiplication, and second, converting digits from 3 to 9 into two digits instead of one.
The multiplier is processed from left to right based on the Zargelin Mathematical Chain (ZMC), where adjacent digits are processed except at the beginning and end, where only a single digit is handled. For all multiplicand digit values greater than 2 and less than 8, 5 must be added to the sum.
Initialization of specific variables to a predetermined value to prepare the system for computation regardless of the multiplicand or multiplier size.
Handling of multiplicand signs for computational accuracy, ensuring proper treatment of positive and negative numbers.
Systematic processing of the multiplicand on a digit-by-digit basis, from the leftmost digit to the rightmost, allowing for immediate input and calculation without needing the entire size of the multiplier at the start.
Real-time computational ability, allowing the algorithm to begin processing results without needing to know the full size or details of the multiplier.
A structured approach to decimal point management, allowing seamless integration of decimal values in both the multiplicand and the multiplier, ensuring accurate results.
Parallel processing of different multiplicand digits by splitting the task into multiple operations, with each digit being processed separately and independently to enhance speed and efficiency.
Dynamic decision-making based on the multiplicand's digit values and repeated values, where the algorithm determines how many temporary registers are required and whether to compute the final result directly (FR) or to compute intermediate results for every multiplicand value (FR_{dv}) first and then sum them up for the final result.
Dynamic decision-making occurs when the multiplicand and multiplier are known in advance, allowing the algorithm to decide whether to keep or invert them based on their digit size, values, and repeated patterns, in order to accelerate the multiplication process.
Use of a temporary register to store intermediate results when all multiplicand digits share the same value, minimizing computational complexity by avoiding redundant operations for repeated digits.
Generation of results from individual multiplicand digits, processed through their respective part algorithms, which are then aggregated and summed up to form the final result.
Accounting for fractional values, incorporating them into the overall multiplication result, and maintaining 100% accuracy for any size of multiplicand and multiplier.
Guaranteed accuracy by design, ensuring 100% correct results across all calculations.
Ability to immediately compute without requiring the size of the full multiplier, enabling the algorithm to work efficiently with inputs of any length or size dynamically.
Scalability to handle multiplicands and multipliers of any size, from small numbers to very large values, ensuring consistent performance.

2. The method of claim 1, wherein said initialization involves setting variables like FR, FR_{dv}, R_{dv}, Rdᵥⱼ, CC, bᵢ, bᵢ₋₁, DF, and FRS to zero.

3. The method of claim 1, incorporating a unique approach that does not rely on traditional multiplication methods.

4. The method of claim 1, wherein said algorithm has an enhanced capability to handle infinite multipliers, ensuring efficient computational operations.

5. The method of claim 1, wherein the systematic processing involves creating unique variables like FR_{dv}, R_{dv}, and R_{dvj} for each digit value, enhancing precision in calculations.

6. The method of claim 1, wherein the handling of multiplicand signs involves adjusting the Final Result Sign (FRS) based on both the multiplicand and multiplier signs.

7. In the method of claim 1, a user-friendly tabular representation or roadmap is provided to navigate through 13 part-algorithms tailored for specific multiplicands, enhancing both accuracy and user experience. For multiplier digits, they are categorized into an initial (a=b₋₁), middle (bᵢ), and final digit (c=bₘ). For all multiplicands less than 8, if the previous digit in the middle section is odd, an addition of 5 is mandated, and similarly, in the final section, if the last digit is odd, 5 is added. Throughout RFMA's algorithms, pairs of digits are processed by a standard protocol: for a two-digit outcome, the tenth place modifies the prior result, and the unit place is integrated. This approach is consistently applied, even for single-digit multipliers, ensuring efficient multiplication.
For the RFMA-12 algorithm:
a) The initial input digit is set in R₁₂.
b) All intermediate digits are processed by adding each current digit to the double of its immediate predecessor.
c) The double of the final digit is annexed to the resultant value in R₁₂.
For the RFMA-11 algorithm:
a) The initial input digit is set in R₁₁.
b) All intermediate digits are addressed by summing each current digit with its immediate predecessor.
c) The concluding digit is appended to the resultant value in R₁₁.
For the RFMA-10 algorithm:
a) The initial input digit is set in R₁₀.
b) All intermediate digits are appended to R₁₀.
c) Zero is appended to the resultant value in R₁₀.
For the RFMA-9 algorithm: The method of claim 1 further comprising multiplying a single digit ‘a’ with 9 may produce (a₋₁) as the tenth digit and (10−a) as the unit digit. This process delineates the three distinct sections:
a) The initial input value is denoted as R₉=(a−1).
b) During intermediate steps, the sum is determined by adding the nines' complement of the preceding digit to the current digit.
c) In the concluding phase, the sum takes on the value of the tens' complement of ‘c’.
For the RFMA-8 algorithm: The method of claim 1 further comprising multiplying a single digit ‘a’ with 9 may result in (a−2) as the tenth digit and 2(10−a) as the unit digit. This process distinguishes the three separate sections:
a) The starting value is represented as R₈=(a−2).
b) In the intermediate phases, the sum is derived by adding double the nines' complement of the prior digit to the current digit.
c) As the algorithm concludes, the sum becomes equivalent to double the tens' complement of ‘c’.
For the RFMA-7 algorithm: The method of claim 1 outlines that when a single digit ‘a’ is multiplied with 7, it may result in (int(a/2)) for the tenth digit and (2a) for the unit digit. This strategy categorizes the operation into three separate sections:
a) The initial value is set as the integer of half of the input digit in R₇.
b) For the intermediate digits, the sum is determined by adding the integer of half of the current digit to double of its immediate predecessor.
c) To finalize, the double of the concluding digit is appended to the accumulated value in R₇.
For the RFMA-6 algorithm: The method of claim 1 details that when a single digit ‘a’ is multiplied with 6, the potential outcome is (int(a/2)) for the tenth digit and (a) for the unit digit. This framework segments the procedure into three distinct sections: a) The initial value is set as the integer of half of the input digit in R₆.
b) Throughout the intermediate steps, the sum is derived by adding each current digit to half of its immediate predecessor.
c) The final digit is annexed to the resultant value in R₆.
For the RFMA-5 algorithm: The method of claim 1 specifies that when a single digit ‘a’ is multiplied with 5, the outcome may be (int(a/2)) for the tenth digit and (0) for the unit digit. This methodology divides the process into three distinct sections:
a) The initial value is defined as the integer of half of the input digit and set in R₅.
b) The integer of half of all intermediate digits are sequentially appended to R₅.
c) In conclusion, zero is affixed to the resulting value in R₅.
For the RFMA-4 algorithm: The method of claim 1 elaborates that when a single digit ‘a’ is multiplied with 4, it may produce (int(a/2)−1) as the tenth digit and (10−a) as the unit digit. This approach demarcates the three specific sections:
a) The initial value is defined as R₄=int(a/2)−1.
b) During the intermediate steps, the sum is generated by combining the nines' complement of the preceding digit with half of the current digit.
c) In the final stages, the sum is characterized as the tens' complement of ‘c’.
For the RFMA-3 algorithm: The method of claim 1 further dictates that multiplying a single digit ‘a’ with 3 may yield (int(a/2)−2) as the tenth digit and 2(10−a) as the unit digit. This procedure defines the three distinct sections: a) The initial value is denoted as R₃=int(a/2)−2.
b) During the intermediate calculations, the sum is determined by adding double the nines' complement of the preceding digit to half of the current digit.
c) Upon conclusion, the sum aligns with double the tens' complement of ‘c’.

8. The method of claim 1, wherein said algorithm showcases a discernible pattern and symmetry in its part-algorithms, simplifying the multiplication process and enhancing its comprehensibility.

9. The method of claim 1, wherein specific paired part-algorithms, such as RFMA-11 with RFMA-6, share foundational principles dictating their respective operations, underscoring the method's structured design.

10. The method of claim 1, designed for diverse applications across sectors like finance, scientific research, technology, and more, showcasing its versatility and wide-ranging utility.

11. The method of claim 1, designed for diverse electronic devices independent on their size.

12. The method of claim 1, designed for hardware implementations and that operates with reduced hardware components.

13. The method of claim 1, designed for light implementations.

14. The method of claim 1, designed for a different arithmetic system such as decimal, 13-system and more.

15. In addition to the method of claim 1, we claim the Decimal Convolution Multiplier Algorithm (DCMA) using standard multiplication in FIG. 4, which can be applied with any type of multiplication:
Processing based on convolution principles allows for simultaneous calculations across multiple sections of the multiplicand and multiplier.
It can be applied to any base or number system, including binary, decimal, or other non-standard number systems.
It handles both whole numbers and fractional components efficiently, ensuring complete accuracy across different inputs.
The convolution method dynamically adjusts based on the size of the multiplicand and multiplier, ensuring optimal processing time for all operations.

16. The method of claim 15, where the Decimal Convolution Multiplier Algorithm (DCMA) uses standard convolution-based multiplication.

17. The method of claim 15, wherein the DCMA leverages convolution principles to compute results for both single-digit and multi-digit multiplication operations, allowing for efficient processing of large-scale inputs.

18. The method of claim 15, where the convolution algorithm ensures accuracy and scalability for various number systems, providing a versatile solution for multiplication operations.
